(19) United States
(12) Patent Application Publication
(10) Pub. No.: US 2004/0111220 A1
(43) Pub. Date: Jun. 10, 2004

(54) Methods of decomposing complex data

(75) Inventors: Michael F. Ochs, Oreland, PA (US); Truman R. Brown, Laverock, PA (US); Radka Stoyanova, Cheltenham, PA (US); Christos Patriotis, Cheltenham, PA (US)

Correspondence Address: MORGAN, LEWIS & BOCKIUS LLP, 1701 MARKET STREET, PHILADELPHIA, PA, 19103-2921, US

(73) Assignee: Fox Chase Cancer Center

(21) Appl. No.: 10/727,071

(22) Filed: Dec. 2, 2003

Related U.S. Application Data
(63) Continuation of application No. 09/609,038, filed on Jun. 30, 2000, now abandoned.
Application No. 09/609,038 is a continuation of application No. PCT/US00/04234, filed on Feb. 18, 2000.
(60) Provisional application No. 60/120,854, filed on Feb. 19, 1999.

(51) Int. Cl. G06F 19/00

(52) U.S. Cl. 702/19

(57) ABSTRACT

The invention includes a computer implemented process to identify at least one pattern and its distribution in a set of data for the purpose of interpreting the data. The process comprises (a) representing a set of data by an original data matrix D residing in a storage device, and; (b) decomposing the set of data into a set of patterns represented by a matrix F and their distribution represented by a matrix A, wherein the matrix F represents the set of patterns needed to describe the data and the matrix A represents the distribution of the set of patterns within the data matrix D, the decomposing comprising performing a Bayesian-based Monte Carlo calculation using at least the data matrix D to determine the matrices A and F, wherein the matrices A and F reconstruct the data matrix D and are more amenable to analysis than the data matrix D. Application of the process to environmental, biological and medical, econometric, and other fields is included in the invention.

### BACKGROUND OF THE INVENTION

In many business and scientific endeavors, data is being gathered at an increasing rate. This has led to the acquisition and storage of enormous amounts of data, which require analysis to be useful, since humans are incapable of understanding information in the form of a large database. The analysis required can be viewed in general as a reduction of dimensionality, since the huge databases are reduced by the analysis to smaller, meaningful structures. These structures generally take the form of either rules (if X, then Y) or patterns (X, Y, and Z occur together). For a full reconstruction of all the knowledge in the database, further information is needed. The patterns must be quantified so that the database can be reconstructed from the patterns and a measure of the amounts of the patterns within the data can be made. Until the data can be reconstructed from some smaller structures, the description of the database in terms of the smaller structures is incomplete and information can be considered to be undiscovered. It is also desirable to have a measure of how well the data is reconstructed from the smaller structures and also whether this is a unique solution or whether other solutions exist, since some solutions may be more useful or may represent the real world better.

There is a fundamental relationship between the problem of decomposing a database into smaller structures together with their quantified distributions and the mathematical problem of decomposing a matrix into two different matrices. If each record in a database is viewed as a row in a matrix with the fields of the data corresponding to columns, then the problem of finding patterns and distributions is similar to the problem of finding the eigenvectors and eigenvalues of a matrix. Although this is true only for numeric databases, coding of the data into numeric form can allow the decomposition for general databases, if such coding is meaningful.

Matrix decomposition is a widely used method in mathematics with application to an entire spectrum of problems in linear algebra, optimization, differential equations, statistics, etc. For these purposes, a large variety of algorithms exist such as Singular Value Decomposition, LU (Lower triangular matrix with 1 s on the diagonal and Upper triangular matrix) Decomposition, Cholesky Decomposition, Spectral/Jordan Decomposition and others. These algorithms are useful for factoring matrices in general and for special matrices such as sparse, square, symmetric, etc.

The fundamental problem with all of these mathematical decomposition methods is that they lead to solutions which are not generally meaningful beyond the mathematics. For example, Principal Component Analysis will reduce a matrix to a series of eigenvectors which are ordered to explain the greatest portion of the variance between the rows of the matrix. In real data, this often allows the user to distinguish signal from noise; however, the solutions are forced to be mathematically orthogonal. This orthogonality condition generally leads to a non-physicality in the solutions, so that interpretation in terms of the meaningful structures in the data becomes either problematic or more often impossible. For example, the decomposition of a series of images of faces will yield not facial features but instead mathematical constructs which, though capable of reproducing the original series of faces, are not interpretable as being related to faces at all.

The field of data mining emerged in order to overcome the limitations of purely mathematical methods such as those noted above. The goal of data mining is to find meaningful patterns or rules within large data sets. Generally this is not done as a method to reconstruct the data, but instead is limited to explaining subsets of the data. The usual data mining procedure involves multiple steps including data selection, data cleaning, data coding, pattern recognition, and reporting. The method described in the present application patent primarily deals with the pattern recognition step; however, its implementation has impact on data cleaning and coding as well.

Traditional pattern recognition methods cover a broad spectrum of methods, however the method presented herein is unlike all previous methods. The closest methodology presently in use is fuzzy sets, where the database is reduced by trying to define sets within the data which have nondefinite boundaries. These methods generally divide the data, but they are not capable of creating meaningful sets which reconstruct the data or where a single record can be described by its quantifiable decomposition into several sets. A method similar to fuzzy sets is rough sets, where the records are divided into those which agree with the statements defining the set, those which agree partially with those statements, and those which do not agree at all. However, this method again does not permit reconstruction of the original data nor the ability to decompose a record appropriately.

Perhaps the most widely used data mining method is clustering. Here the database is divided into regions which contain records. Each record belongs to some cluster and the clusters are expected to define the behavior of the records. It is obvious that this simplification loses information, since the set of clusters cannot possibly restore the original database whenever the behavior of a record is complex (i.e. whenever it lies on the boundary of a cluster). Clustering is widely used because it is an easily applicable method and a number of clustering methods have been developed, including fry clustering, Bayesian clustering, supervised clustering, etc. The novel method described herein can be considered a new version of clustering in which the clusters are defined such that records do not need to belong to one cluster. In this case, the database is reconstructed from the clusters, however these clusters do not contain records but instead contain pieces of each record. Each record then belongs to multiple clusters where the belonging is “quantified” by a parameter describing how much of the behavior of an individual sample is explained by that cluster.

Presently the methodologies which come closest to reproducing the ability of the method herein to describe fully the data are neural networks. These include radial basis function networks, self organizing maps, image recognition neural networks, and others. Such neural networks attempt to reduce the data by clustering or pattern recognition. Their success is variable with the problem; however, they all suffer from one overriding concern—neural networks are black boxes, so that any output cannot be evaluated for reliability. In other words, the output of a neural network may not be the best solution and the best solution may actually not have the same characteristics as that identified by the neural network.

Recently another group of methods, known as blind, source separation and independent component analysis received attention because of their potential to recover independent sources given only sensor observations that are unknown linear mixtures of the unobserved independent source signals. The independence condition in these approaches is limiting for identification of temporal or spatial patterns which are overlapping. Furthermore, blind source separation generally requires a well defined physical model of the measuring environment.

Finally many new procedures fall under the rubric of Bayesian methods or machine learning. In essence these are not new methods. Bayesian methods use the Bayesian formulation of statistics to replace or augment the other statistical methods. However, they do not in themselves represent a new data mining method per se. Machine learning describes an outcome more than a method. In this case the desire is to “teach” the computer to recognize patterns of behavior, so that when certain events occur the outcome can be predicted. The method of the present invention could be considered such “learning” since the identification of fundamental meaningful patterns and their relationships allows the prediction of behavior.

The present methodology fills a gap which exists in data mining. The methods such as clustering, fizzy sets, and rough sets cannot truly decompose the full database into meaningful patterns which can reconstruct it entirely. Neural networks cannot guarantee that the patterns identified are the best patterns given the data or that there are not multiple possible patterns, each set of which is equally good at describing the data. The method described herein does both of these things. It decomposes the database into meaningful, smaller patterns and determines the distribution of those patterns within the data. In addition, because it accomplishes this by exploring the space of possible solutions, it identifies multiple solutions which reconstruct the database equally well. Furthermore, it provides an indication of the strength of each solution by measuring each solution's ability to reconstruct the data. As such, the method described herein offers a new way to handle matrix decomposition and data mining, improving on previous methods.

### SUMMARY OF THE INVENTION

The invention includes a computer implemented process to identify at least one pattern and its distribution in a set of data for the purpose of interpreting the data The process comprises (a) representing a set of data by an original data matrix D residing in a storage device, and; (b) decomposing the set of data into a set of patterns represented by a matrix F and their distribution represented by a matrix A, wherein the matrix F represents the set of patterns needed to describe the data and the matrix A represents the distribution of the set of patterns within the data matrix D, the decomposing comprising performing a Bayesian-based Monte Carlo calculation using at least the data matrix D to determine the matrices A and F, wherein the matrices A and F reconstruct the data matrix D and are more amenable to analysis than the data matrix D.

In one aspect, the process further comprises (c) determining by Monte Carlo sampling the uncertainties of all values in the elements of matrix F and matrix A.

In another aspect, the decomposing is performed such that the combined number of the elements in the matrices A and F are significantly smaller than the number of elements of the original data matrix, and the uncertainties in the matrices A and F combine to yield the correct uncertainty in matrix D, the significantly smaller number of elements making the matrices A and F more amenable to analysis than the data matrix D.

In yet another aspect, the process further comprises (c) using a statistical process to determine the number of independent patterns required to reconstruct the original data matrix D within a noise level from the subordinate matrices A and F.

In a preferred embodiment, the independent patterns are spectral shapes.

In yet another preferred embodiment, the statistical process is principal component analysis, and the process further comprises (c) using the principal component analysis to correct for any instrumental frequency or phase shifts which appear in spectra of the original data matrix D.

In an additional embodiment, rows of the original data matrix D are chemical shift imaging spectra associated with specific locations in a living organism, rows of matrix F are individual nuclear magnetic resonance (NMR) spectra associated with different tissue types, and rows of matrix A are amounts of each tissue type at each specific location within the living organism.

A further embodiment includes that rows of the original data matrix D are NMR spectra-associated with specific time points during an observation of a living organism, rows of matrix F are individual NMR spectra associated with different chemical species, and rows of matrix A are amounts of each chemical species at each time point

In yet an additional embodiment, rows of the original data matrix D are NMR recovery curves associated with specific locations within a living organism, rows of matrix F are individual NMR recovery curves associated with different tissue types, and rows of matrix. A are amounts of each tissue type at each specific location within the living organism.

In another aspect of the invention, rows of the original data matrix D are levels of expression of individual messenger RNA (mRNA) species at specific times, rows of matrix F are patterns of physiologically related mRNA expression, and rows of matrix A are amounts of each expression pattern at each specific point in time.

In one embodiment of this aspect of the invention, the process further comprises (c) measuring the mRNA levels by adding a detectable label to DNA derived from the mRNA; and (d) quantitating the amount of label associated with the DNA as a measure of the mRNA levels.

In a preferred embodiment, wherein the label is selected from the group consisting of a radioactive label and a non-radioactive label.

In another embodiment, expression of the mRNA is measured by synthesizing a DNA molecule which is complementary to the mRNA and detecting the amount of DNA synthesized. Preferably, the DNA molecule is synthesized in a reverse transcriptase reaction. Also, preferably, the amount of DNA synthesized is measured by (c) adding a detectable label to the DNA; and (d) quantitating the amount of label associated with the DNA as a measure of the amount of DNA synthesized. Additionally preferably, the label is selected from the group consisting of a radioactive label and a non-radioactive label.

In another embodiment, expression of the mRNA is measured by amplifying the mRNA to DNA and detecting the amount of DNA so amplified. Preferably, the amplifying is conducted in a polymerase chain reaction. Alternatively, the mRNA levels are measured using an array. In other embodiments, the array is a high density gene chip array or a low density array. When the array is a low density array, it is a filter or a plate array.

In another aspect of the invention, rows of the original data matrix D are levels of expression of individual messenger RNA (mRNA) species at specific locations within a living organism, rows of matrix F are patterns of physiologically related mRNA expression, and rows of matrix A are amounts of each expression pattern at each specific location in the organism.

In one embodiment, the process further comprises (c) measuring the mRNA levels by adding a detectable label to DNA derived from the mRNA; and (d) quantitating the amount of label associated with the DNA as a measure of the mRNA levels. As before, the label is selected from the group consisting of a radioactive label and a non-radioactive label.

Further, wherein expression of the mRNA is measured by synthesizing a DNA molecule which is complementary to the mRNA and detecting the amount of DNA synthesized. Preferably, the DNA molecule is synthesized in a reverse transcriptase reaction. Further, the amount of DNA synthesized is measured by (c) adding a detectable label to the DNA; and (d) quantitating the amount of label associated with the DNA as a measure of the amount of DNA synthesized. The label is again a radioactive label or a non-radioactive label.

In addition, expression of the mRNA is measured by amplifying the mRNA to DNA and detecting the amount of DNA so amplified. The amplifying is conducted in a polymerase chain reaction. Further, the expression of mRNA is measured using an array, which may be a high density gene chip array or a low density array. In the latter instance, the low density array is a filter or a plate array.

In another aspect of the invention, rows of the original data matrix D are amounts of individual DNA species in specific individuals, rows of matrix F are patterns of physiologically related DNA species, and rows of matrix A are amounts of each DNA pattern in each individual.

In one embodiment, the amount of DNA is measured by hybridizing to the DNA a complementary DNA having a detectable label attached thereto and measuring the amount of label so hybridized as a measure of the amount of DNA. The label is selected from the group consisting of a radioactive and a non-radioactive label.

In another embodiment, the amount of individual DNA is measured by synthesizing a DNA copy of the DNA to generate a synthesized DNA, wherein the synthesized DNA has a detectable label attached thereto and measuring the amount of label in the synthesized DNA as a measure of the amount of DNA. Preferably, the amount of DNA (non-amplified DNA) may be measured by amplifying the DNA (amplified DNA) in the presence of a detectable label; and measuring the amount of label associated with the amplified DNA as a measure of the amount of non-amplified DNA. The amplifying may be conducted by a polymerase chain reaction and the amount of individual DNA is measured on an array which may be a high density gene chip array or a low density array. In the latter instance, the low density array is a filter or a plate array.

In a further aspect of the invention, rows of the original data matrix D are amounts of individual DNA species at specific locations in a living organism, rows of matrix F are patterns of physiologically related DNA species, and rows of matrix A are amounts of each DNA pattern at each specific location in the organism.

In one embodiment of this aspect of the invention, the amount of DNA is measured by hybridizing to the DNA a complementary DNA having a detectable label attached thereto and measuring the amount of label so hybridized as a measure of the amount of DNA. In a preferred embodiment, the amount of individual DNA is measured by synthesizing a DNA copy of the DNA to generate a synthesized. DNA, wherein the synthesized DNA has a detectable label attached thereto and measuring the amount of label in the synthesized DNA as a measure of the amount of DNA. In addition, the amount of DNA (non-amplified DNA) is measured by amplifying the DNA (amplified DNA) in the presence of a detectable label and measuring the amount of label associated with the amplified DNA as a measure of the amount of non-amplified DNA. The amplifying is conducted by a polymerase chain reaction and the amount of individual DNA is measured on an array which may be a high density gene chip array or a low density array. When the array is a low density array, it a is a filter or a plate array.

In yet another aspect of the invention, rows of the original data matrix D are amounts of individual DNA species at different times in a living organism, rows of matrix F are patterns of physiologically related DNA species, and rows of matrix A are amounts of each expression pattern at each specific point in time.

In one embodiment, the amount of DNA is measured by hybridizing to the DNA a complementary DNA having a detectable label attached thereto and measuring the amount of label so hybridized as a measure of the amount of DNA.

The amount of individual DNA is measured by synthesizing a DNA copy of the DNA to generate a synthesized DNA, wherein the synthesized DNA has a detectable label attached thereto and measuring the amount of label in the synthesized DNA as a measure of the amount of DNA. The amount of DNA (non-amplified DNA) is measured by amplifying the DNA (amplified DNA) in the presence of a detectable label; and measuring the amount of label associated with the amplified DNA as a measure of the amount of non-amplified DNA. The amplifying is conducted by a polymerase chain reaction and the DNA may be measured on an array as previously described.

The process of the invention also includes that rows of the original data matrix D are measurements of individual samples comprising mixtures of chemical compounds, rows of matrix F are the measurements associated with a single chemical compound, and rows of matrix A are amounts of each chemical compound in each of the individual samples.

In one aspect, the rows of the data matrix D are gas chromatography/mass spectra (GCMS) measurements, and the rows of matrix F are the GCMS spectra for the individual chemical compounds. In one embodiment, the rows of the data matrix D are infrared spectroscopy measurements, and the rows of matrix F are the infrared spectra for the individual chemical compounds. In another embodiment, the rows of the data matrix D are optical absorption spectroscopy measurements, and the rows of matrix F are the optical absorption spectra for the individual chemical compounds. In yet another embodiment, the rows of the data matrix D are fluorescence spectroscopy measurements, and the rows of matrix F are the fluorescence spectra for the individual chemical compounds. In a further embodiment, the rows of the data matrix D are high pressure liquid chromatography/standard detection measurements, and the rows of matrix F are the spectra for the individual chemical compounds, wherein the spectra are selected from the group consisting of GCMS spectra, infrared spectra, optical absorption spectra and fluorescence spectra Within the process of the invention, at least one pattern may be a monetary value, or an amount of goods or services. Preferably, the rows of the data matrix D are amounts of goods and services at various times, the rows of matrix F are the patterns of goods and services, and the rows of matrix A are a measure of how the amounts of goods and services are distributed over time. Alternatively, rows of the data matrix D are amounts of goods and services at various locations, the rows of matrix F are the patterns of goods and services, and the rows of matrix A are a measure of how the amounts of goods and services are distributed over various locations.

Further, the pattern distribution may be across entities, across a space or a location or across time.

Further, the process of the invention includes representing a set of data by an original data matrix D which involves counting a number of occurrences of events within the set of data and encoding the number of occurrences into the original data matrix D.

In addition, the process of the invention includes wherein the original data matrix D is a set of spatially dependent functions, matrix F is a fixed set of spatially dependent functions, and matrix A is a distribution of the fixed spatially dependent functions within the data matrix D.

The process also includes wherein the original data matrix D is a series of images, matrix F is a set of unvarying images and A is a measure of how the images in matrix F are distributed in data matrix D. In one embodiment, the original data matrix D is a set of images acquired at different wavelengths. In another embodiment, the original data matrix D is a set of images acquired at different times.

The process of the invention also includes wherein the data matrix D is a set of measurements representing behavioral studies, a set of measurements representing clinical studies, a set of measurements representing biomedical research studies, and a set of measurements representing psychodynamic studies.

### BRIEF DESCRIPTION OF THE DRAWINGS

FIG. 1 illustrates the primary flow of the decomposition method of the invention through a single data analysis.

FIG. 2 shows the Markov chain Monte Carlo/Bayesian methodology which operates within blocks 800 and 810 of FIG. 1.

FIG. 3 shows the application of Principal Component analysis which operates within block 200 of FIG. 1.

FIG. 4 shows the phasing and shifting of the data which operates within block 400 of FIG. 1.

FIG. 5, comprising FIGS. 5a-5d, shows time series data for the catabolism of 5-FU to FBAL. FIG. 5a: The data contain 51 points extracted from 30 one minute, nonlocalized ¹⁹F NMR spectra with peak SNR 7 acquired over 30 minutes following rapid (one minute) bolus injection of 5-FU. The time series runs from top to bottom and the location of the 5-FU and FBAL peaks are shown. FIG. 5b: The amplitudes of the two underlying spectral shapes within the data determined using the method of the invention. The time axis runs from 1 to 30 minutes. FIG. 5c: The two underlying spectral shapes determined using the method of the invention. At top is the 5-FU spectrum; at bottom is the FBAL spectrum with the RF carrier showing in the middle. FIG. 5d: An exponential fit by regression analysis to the decay of the amplitude of the 5-EU signal. A time constant of 7.61 minutes (+1.90/−1.27 minutes at 95 confidence) was determined.

FIG. 6, comprising FIGS. 6a-6d, shows CSI dataset (8×8×4 voxels of 22 cm³ each) from the human head of a normal volunteer. FIG. 6a shows ³¹P spectra from a single axial slice. 64 of 256 total spectra are shown. FIG. 6b shows the corresponding ¹H image centered axially on the region of the voxels. FIG. 6c shows the 8×8 amplitude distributions are shown with slight Gaussian blurs applied to make the distributions easier to see. The intensity scale is the same in both distributions to aid in comparison. At top is the distribution for the spectral shape characteristic of muscle tissue, while at the bottom is the distribution for the spectral shape characteristic of brain tissue. FIG. 6d shows at top the reconstructed spectral shape associated with muscle which shows sharp beta-ATP lines centered at −18.62 ppm with PCr set at −2.52 ppm. At bottom is the reconstructed spectral shape associated with brain which shows beta-ATP centered at 18.92 ppm with PCr set at −2.52 ppm. The lineshape used in the method of the invention was Gaussian with width 5.7 points.

FIG. 7, comprising FIGS. 7a and 7b, shows second solution for head data with no zeros set in the brain tissue. FIG. 7a shows amplitude distributions for two solutions, again on the same scale. Top solution is “muscle-like”; however it now encroaches into the brain tissue region. FIG. 7b shows spectra corresponding to the distributions with linewidths of 5.7 points as in FIG. 2. The spectra are similar except that the “brain-like” spectrum has lost its PCr, while the beta-ATP and PME regions are mixed between the two solutions.

FIG. 8, comprising FIGS. 8a-8f, shows lots of full datasets, reconstructions, and residuals for head data. Each plot contains 256 spectra of 369 points each shown from left to right together with an average across all the spectra at the far right, FIGS. 8a and 8b. The input datasets (identical to each other) with the low SNR and large variations apparent FIG. 8c is a reconstruction from the solution shown in FIG. 6. FIG. 8d is a reconstruction from the solution shown in FIG. 7. FIG. 8e shows residuals, FIGS. 8a-8b, for the reconstruction in 8c. FIG. 8f shows residuals, 8b-8d, for the reconstruction in 8d.

FIG. 9, comprising FIGS. 9a and 9b shows model spectra and distributions. FIG. 9a shows three model spectra showing shifts of peaks between them. FIG. 9b shows amplitude distributions for spectra, top spectrum goes with left distribution, middle spectrum with middle distribution, bottom spectrum with right distribution.

FIG. 10, comprising FIGS. 10a-10d, shows sample data spectra from model in FIG. 9 together with Gaussian noise. FIG. 10a shows peak SNR of 8 for ATP peaks. FIG. 10b shows peak SNR of 6 for ATP peaks. FIG. 10c shows peak SNR of 4 for ATP peaks. FIG. 10d shows peak SNR of 2 for ATP peaks.

FIG. 11, comprising FIGS. 11a and 11b, shows two solutions found using the method of the invention for the highest SNR case. FIG. 11a shows a first solution with higher root mean square misfit to the known distributions. FIG. 11b shows a second solution with lower root mean square misfit to the known distributions.

FIG. 12 shows a “Bad” solution found in second highest SNR case: The root mean square misfit to the known distribution is roughly twice that for the “good” solution.

FIG. 13, comprising FIGS. 13a and 13b, shows residual plots between the data and the reconstruction for solutions at the second highest SNR ratio. FIG. 13a shows a plot for “good” solution. FIG. 13b shows a plot for “bad” solution.

FIG. 14, comprising FIGS. 14a-14d, shows CSI dataset (156 spectra from 2 axial slices of human calf muscle). FIG. 14a shows one ¹H image with the 16×16 overlay for the CSI voxels together with a box indicating the location of the spectra shown in FIG. 14b. FIG. 14b shows ³¹P spectra from the region outlined in FIG. 14a (25 of 156 spectra shown). FIG. 14c shows the 16×16 amplitude distribution for the three reconstructed spectral shapes. At the top is shape 1, in the middle is shape 2, at the bottom is shape 3. Although 16×16 voxels are shown, the dataset does not-include voxels outside the leg, so these are automatically set to zero amplitude. FIG. 14d shows the three reconstructed spectral shapes, numbered from top to bottom. Gaussian lineshapes with widths of 5 points were used in the method of the invention. See Table 2 for a summary of the peak locations and the differences between spectra.

FIG. 15, comprising FIGS. 15a and 15b, shows the results of applying the method of the invention in an analysis of a series of 64 relaxographic images. The images (FIG. 15a) are-of the central 32×32 region fully within the brain of the full 64×64 dataset. The images are white matter (top panel, FIG. 15a), gray matter (middle panel, FIG. 15a) and cerebrospinal fluid (bottom panel, FIG. 15a), with T₁ recovery time constants of 1.05±0.05 s, 1.67±0.2 s, and 3.5±1.2 s, which were determined simultaneously with the distributions (FIG. 15b).

FIG. 16, comprising FIGS. 16A and 16B, is an autradiographic image of Atlas™ cDNA arrays hybridized to cDNA probes from control (FIG. 16A) and apoptotic (FIG. 16B) cell lines. The images were obtained by scanning with a Microtek ScannmakerIII at 1000 dpi and 16 bit resolution. The final row of each image contains control genes which should have equal expression in all cell lines, allowing calibration of the autoradiographs.

FIG. 17, comprising FIGS. 17a-17d, shows the results of applying the method of the invention to an analysis of simulated data which shows increase in mRNA levels for a series of genes during apoptosis. The top patterns (FIG. 17a and FIG. 17b) simulate gene patterns which are constant within the noise level during the experiment. The bottom patterns (FIG. 17c and FIG. 17d) are for genes which turn on and increase in a coordinated fashion during apoptosis (scales are not matched between top and bottom—bottom amplitudes are actually smaller). The four basic patterns used to create the simulated dataset were (a), (b), (a+d) and (b±c). The second small amplitude line in each case is the deviation from the known, simulated value. The distributions of these patterns are not shown as the simulation was done using random distributions.

FIG. 18 shows the correlation plot of the intensities of all detected genes on the HIO-118 derived versus HIO-118NuTu derived cDNA arrays. Genes whose intensity fluctuate within the threshold (noise) level around the trend line (circles) are shown together with their correlation trend line. Genes whose expression increases in tumorigenic cells (triangles) appear above the trendline, while genes whose expression decreases or is absent in tumorigenic cells (squares) appear below the trend line.

FIG. 19 is four patterns identified within credit card data showing the relationship of various attributes to each other. The final attribute is the return.

FIG. 20 is a graph showing the time behavior of each of the four patterns in FIG. 19. The results demonstrate that pattern 1 had a significant increase around 42 months into the existence of the credit card aggregate.

### DETAILED DESCRIPTION OF THE INVENTION

The invention relates to the application of a mathematical algorithm to decompose complex sets of data into manageable useful entities. Specifically, the invention includes a statistically based data mining process, wherein complex sets of data are reduced to manageable and useful entities. With the development of new acquisition methods which generate massive informational databases in biotechnology, economics and other information, there has emerged a great need for methods to manage, assess and reduce such information into useful entities.

The present invention has application to the management of information in econometrics, including, but not limited to: forecasting, such as the analysis of past and present econometric data to predict future trends; financial market analysis of stocks, bonds, derivatives, options, commodities and money; financial measurements; measurement of any part of the marketing cycle-planning, execution, analysis, and control (verification and validation). The invention also has application to population and demographic studies and census data. Further, the invention has application to environmental data analysis. The invention has additional application to biological and medical analyses, such as, but not limited to clinical trial experiments, biological databases, including, but not limited to, genomic databases, combinatorial chemistry, image analyses, behavior, sociological and psychological studies.

The method of the present invention is a statistically based data mining process. It has many advantages over traditional data mining processes, especially in areas of data cleaning, coding, and pattern recognition. Like neural networks and genetic algorithms, the method discovers patterns in complex data sets. However, the statistical basis of the method allows it to discover the patterns and their reliability, variance, and other factors which greatly enhance their usefulness for making decisions. Furthermore, the method is based on a complex mathematical procedure which reduces multidimensional data sets to the minimal meaningful sets which describe the data.

The method of the invention functions primarily at three stages in the traditional data mining operation. Data selection is not done in performance of the method and it is assumed that the input data has been suitably selected. In the cleaning step, the method typically uses Principal Component Analysis (PCA) to identify artifacts and outliers in the data set. An iterative corrective process is used, where appropriate, to correct artifacts and remove outliers. These outliers are kept for later use during the reporting stage as they often represent opportunities discovered through the data mining process.

In the coding stage, the statistical basis of the method allows it-to be far more powerful than typical data mining techniques. During the coding phase most data mining tools scale the data to make each aspect of the data equally important. In general this is at best an approximation to the true desire, which is to allow strong or well measured data to take precedence over weak or poorly measured data. The method eliminates the need for scaling by allowing each piece of data to have its own associated uncertainty. This eliminates a second problem with typical coding methods as well, since instead of separating data in an ad hoc manner into groups (e.g. income 30,000-40,000 rather than 35,000-45,000), the method allows continuous distributions with significance defined by the uncertainty. This permits adequate freedom to discover important patterns without preordained, ad hoc constraints that can hide such patterns.

During the data mining stage, the method finds patterns within the data sets, automatically accounting for the uncertainty at each point, so that points which show high natural variation do not constrain the results. This correct usage of uncertainty allows the method to use all the data and to handle correctly data which lies at the borders-of the traditional bins. In some instances, the discovered patterns will be essentially a form of association rule. Presently association rules are useful in data mining only if there is a rough idea of what is sought, but this is no longer true with using the present method. The present method has the freedom to look for any possible pattern within the data, so that it is no longer necessary to have a preconceived notion of where to look for associations, since the method will find them. Furthermore discovered rules will apply across all the data, allowing significant patterns to be identified even when they account for only part of the behavior of a sample, a feature which cannot be matched in the usual systems which rely on clustering and other traditional processes to find association rules.

During the reporting stage, the method not only presents the patterns discovered but also their distribution within the data set. This permits refinement during decision making following discovery of the pattern. Traditionally discovered patterns do not lead to a detailed understanding of the behavior of individual samples since binning and clustering cause a loss of complexity—complexity that defines true behavior. The method finds both patterns and distributions allowing a more thorough understanding of the behavior of individual samples. This better understanding leads to better decision making, since a complex world requires a complex approach.

The method also permits the analysis of outliers removed prior to mining. These outliers may represent the best targets for post-mining analysis. Often, an outlier will represent an unfulfilled pattern. For instance, if there were a pattern relating income and housing costs to new car purchases, an outlier might fulfill the correct income and housing costs without a new car purchase. The targeting of a sales effort in light of such information is obvious.

A pilot project described in more detail elsewhere herein analyzed an aggregated set of credit card data to determine the feasibility of using the method of the invention to develop a long-term forecasting model. These data consisted of 129 credit card fields for aggregates consisting of several thousands of card holders over a period of five years. Actuals and forecasts were provided for a number of aggregates with actuals ranging from one to 58 months and forecasts covering five to 12 months. This limited pilot analysis suggested that a full-blown project could provide a bank with a tool which would predict new account behavior, identify changes in behavior as they occur, notify when intervention to stimulate continued growth is needed, and track the effects of outreach programs. In addition, more extensive future analysis at a sub-segment level of purchasing patterns of individual accounts could produce more insights into the bank customers' behavior.

Thus, the method of the invention uncovered a proposed forecasting tool having the following proposed features: discovery of patterns which together can empirically model all credit cards accounts in a bank database; and, prediction of outcomes for specific scenarios applied to specific segments (scenario planning).

THE METHOD AND APPARATUS OF THE PRESENT INVENTION

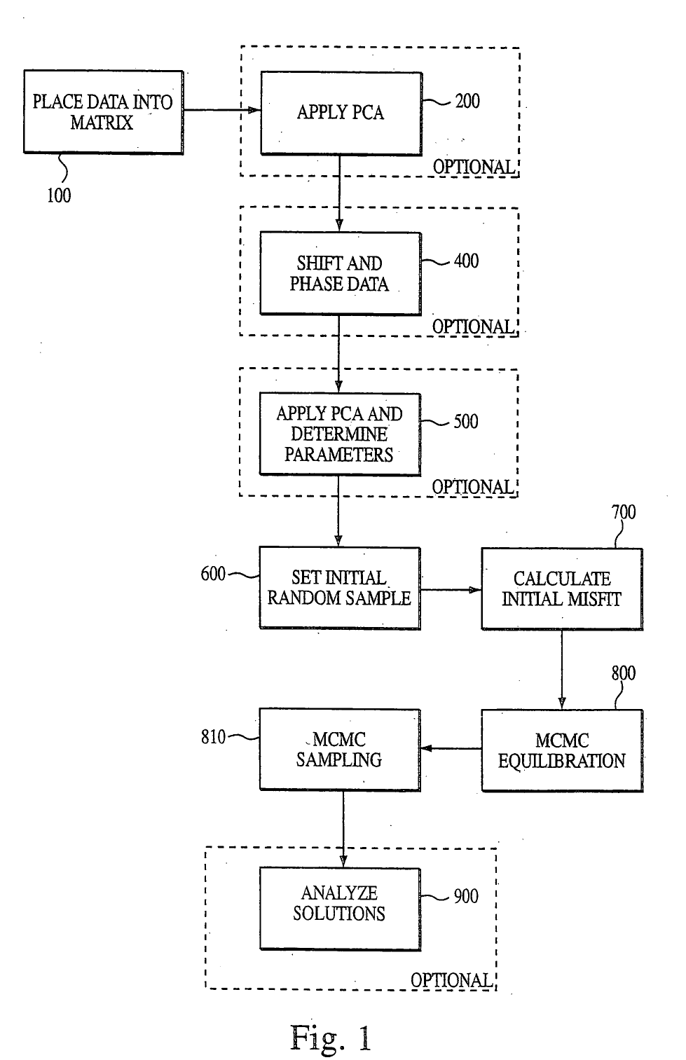

The method and apparatus of the present invention will now be discussed with reference to FIGS. 1-4. Some of the steps of the decomposition method are optional and are labeled as such in FIG. 1.

The present invention has as its input a dataset 100 which represents the results of measurements on a physical system, which could include biological, chemical, mechanical, econometric, or other forms of physically meaningful data. These data can be represented in any form, for instance ASCII data files, unformatted data files on a specific system such as a UNIX workstation or Laboratory Information Management System (LIMS), or a hypertext file transmitted over the worldwide web (WWW) among other possibilities. The data represents a series of measurements, for example spatial or temporal measurements, although any set of related measurements are acceptable, of a set of quantities, which may be related to a physical system such as measurements of metabolites in the human body. These data therefore can be represented as a matrix with the rows representing the individual measurements and the columns representing the series of physical quantities within each measurement.

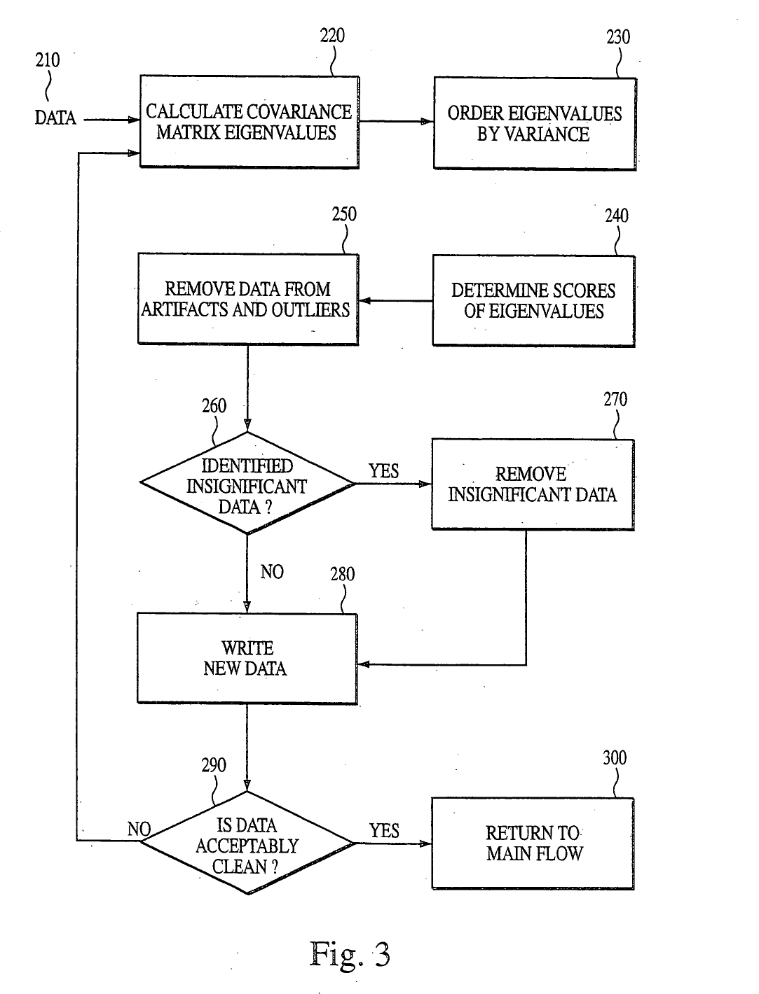

The data is converted into the data format used by the computing system, for example, unformatted data on a Digital UNIX workstation or an ASCII file. Principal component analysis (PCA) is then applied to the dataset (step 200). FIG. 3 shows the application of PCA to a dataset representing multiple measurements. The input data 210 is identical to the original data 100. PCA calculates by standard mathematical methods the covariance matrix and determines its eigenvalues (step 220). It then orders these eigenvalues by how much of the total variance in the data they explain, from greatest proportion to smallest (step 230). The eigenvectors corresponding to these eigenvalues are determined by standard mathematical methods and their scores (the percentage of each data series, or row of the data matrix, which they explain) are determined by projection onto the data (step 240). Any data series which shows artifacts or is an outlier in the view of the operator is removed from the dataset (step 250). In addition, if insignificant data is discovered, (i.e., data series which only add noise to the data) such data can be removed if the operator so desires (steps 260, 270). The data without the artifacts, outliers, and insignificant data are then recorded as a new dataset (step 280). The operator looks at the eigenvalues and eigenvectors to determine if the data looks clean (step 290), and if so, then PCA is done and the process returns to the main flow in FIG. 1 (step 300). If not, then the new dataset (step 280) is passed through the process again beginning at step 220.

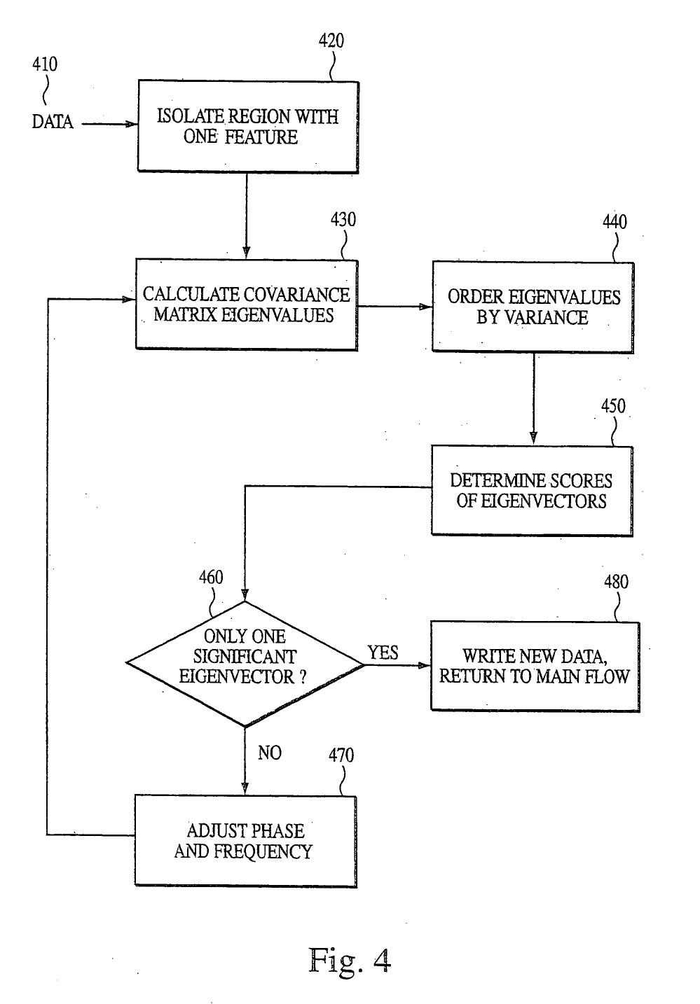

The following paragraph particularly applies to specific analyses, e.g., for the analysis of spectral data and is illustrated primarily in FIG. 4. Subsequent to the above-described steps, the data may then be aligned and phased if necessary (step 400). The input data 410 is the data out of step 200 in FIG. 1 (step 300 in FIG. 3). A single region of the data series is chosen by the operator for the presence of a single feature (spectral line, set of peaks, etc.) (step 420 ). For this region, the covariance matrix is calculated by standard mathematical techniques and its eigenvalues are determined (step 430 ). These eigenvalues are ordered by how much of the total variance in the dataset of the region they explain, from greatest proportion to smallest (step 440). The eigenvectors corresponding to these eigenvalues are determined by standard mathematical methods and their scores (the percentage of each data series, or row of the data matrix representing the single region, which they explain) are determined by projection onto this data (step 450). The operator then looks at the data to determine if there is only one significant eigenvector (step 460), and if so, then applies all of the corrections determined to the whole dataset, writes it, and returns to the min flow in FIG. 1 (step 480). If not, estimates of the shift in the data in each data series and of the phase error in each data series are made from the scores of the eigenvectors and corrections are applied to the dataset from the single region (step 470). This corrected dataset is then analyzed again beginning with step 430. This aligned and phased data is again run through PCA as described above for FIG. 3.

An initial random set of F and A values (a model) is generated (step 600). Using this uninformative sample, an initial calculation of how well the model fits the data is made (step 700).

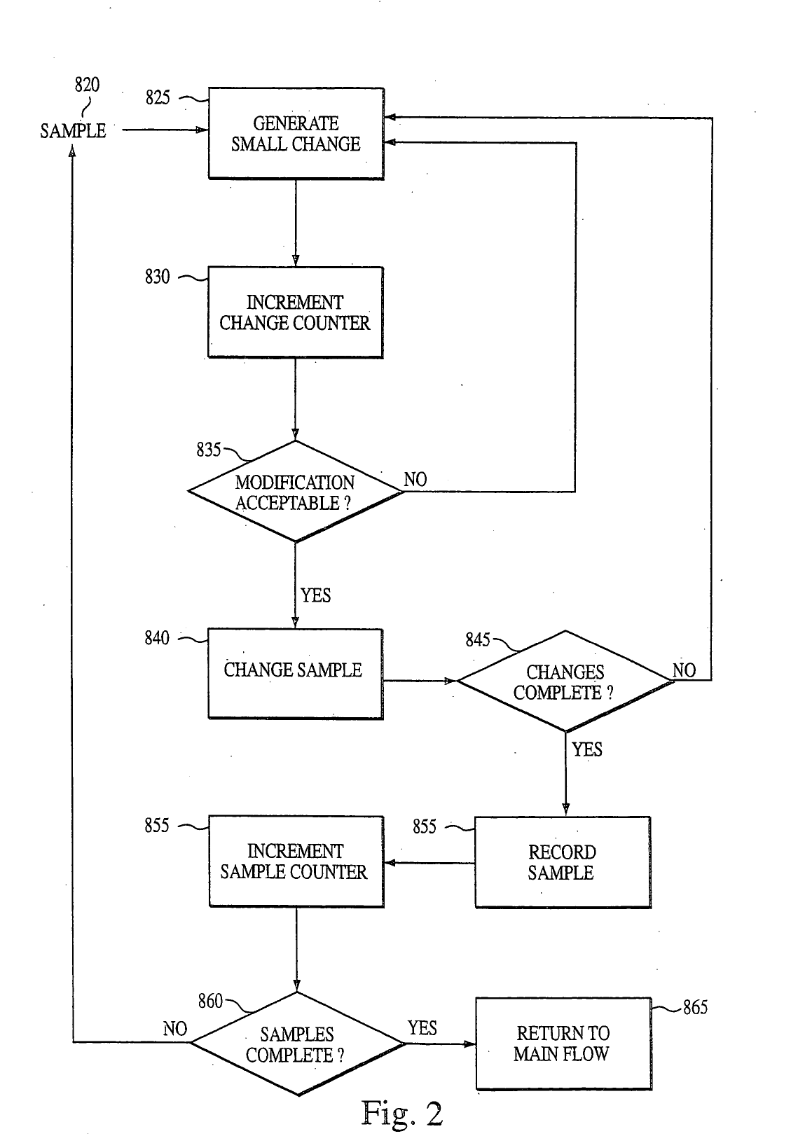

Since the model representing the quantities of interest, which may represent physical parameters, economic values, or any other quantity, is determined through application of Markov chain Monte Carlo procedure, a certain “burn-in” time is required during which the Markov chain reaches areas where the model is highly probable, i.e., portions of the solution space where it is likely that the model is correct given the data. This step is referred to as MCMC Equilibration (step 800), and a description of its operation is given in FIG. 2.

The sample 820 on first calling the MCMC Equilibration (step 800) is the same as the initial uninformative sample (step 600). A small change to this sample is generated at a random position within the sample with a flux chosen at random from a gamma distribution around the average flux per atom (step 825). A counter which keeps track of the number of small changes attempted is incremented (step 830). The method then determines whether this modification is allowable by asking if the change in the likelihood of the model represented in the sample is improved or is made worse by only an amount smaller than a random number chosen from a uniform distribution between zero and one (step 835). If the modification is not allowable, no changes are made in the sample and the next attempt at change is made (step 825). If the modification is allowable, the sample is updated by adding the small change to it and the misfit between the data and the sample is recalculated (step 840). The method checks whether the number of changes attempted is equal to a random number chosen to be near the total number of points in the sample (step 845). If the number of changes made is less than the number desired, the next small change is generated (step 825). Otherwise, the sample is recorded (step 850) and the counter which keeps track of the number of samples generated is incremented (step 855). The method checks whether the number of samples recorded is equal to a number specified by the user (step 860). If the number recorded is less than the number desired, the present sample is used as the input sample (step 820) to begin the process of FIG. 2 again. If the number recorded is equal to the desired number, the method returns to the main flow (step 865) of FIG. 2.

At this point, the MCMC Equilibration process (step 800) has been completed. The samples recorded so far are discarded, and MCMC Sampling begins (step 810). MCMC Sampling 810 follows the same process as MCMC Equilibration process (step 800) described in the last paragraph and entails steps 820 to 865, except that the initial uninformative sample from step 600 is replaced with the final sample from Equilibration step 800 as the starting sample.

The final output from step 810 is analyzed (step 900). This output includes both a mean value, samples of its distribution, and statistics concerning the uncertainty of all values in the mean.

Broadly summarized, the present invention is a computer implemented process to identify at least one pattern and its distribution in a set of data for the purpose of interpreting the data. The process comprises representing a set of data by an original data matrix D residing in a storage device, and decomposing the set of data into a set of patterns and their distribution represented by two matrices A and F. The matrix F represents the set of patterns needed to describe the data and the matrix A represents the distribution of the set of patterns within the data matrix D. The decomposing comprises performing a Bayesian-based Monte Carlo calculation using at least the data matrix D to determine the matrices A and F (steps 800 and 810 of FIG. 1). The matrices A and F reconstruct the data matrix D and are more amenable to analysis than the data matrix D. More specifically, the decomposing is performed such that the combined number of the elements in the matrices A and F are significantly smaller than the number of elements of the original data matrix, and the uncertainties, in the matrices A and F combine to yield the correct uncertainty in matrix D. The significantly smaller number of elements make the matrices A and F more amenable to analysis than the data matrix D.

The method further comprises determining by Monte Carlo sampling the uncertainties of all values in the elements of matrix F and matrix A. Also, the method further comprises using a statistical process to determine the number of independent patterns required to reconstruct the original data matrix D within a noise level from the subordinate matrices A and F (step 200 of FIG. 1, also shown in expanded detail in FIG. 3).

The independent patterns may be spectral shapes and the statistical process may be principal component analysis. In this embodiment, the principal component analysis corrects for any instrumental frequency or phase shifts which appear in the spectra of the original data matrix D (step 400 of FIG. 1, also shown in expanded detail in FIG. 4).

### APPLICATIONS OF THE INVENTION

As noted elsewhere herein, the present invention has particular applicability in the field of econometrics. Econometrics, as used herein, includes:

(1) Forecasting—analysis of the past and present econometric data to predict the future;

(2) Financial markets analysis—stock, bonds, derivatives, option, commodities, money;

(3) Financial measurements;

(4) Measurement of any part of the marketing cycle-planning, execution, analysis, control (verification and validation);

(5) Population/demographic studies, census data;

(6) Medical, biological, and environmental data analysis;

Using the present invention, the nature of relationships in econometric, business and marketing data may be better understood. In one example of an application, at least one pattern is a monetary value, or an amount of goods or services.

Furthermore, the pattern distribution is across entities, across a space or a location, or across time.

In another econometrics application, representing a set of data by an original data matrix D involves counting a number of occurrences of events within the set of data and encoding the number of occurrences into the original data matrix D. Events can mean events, transactions, responses, web page hits, visits, words, phrases, sentences, paragraphs, and sound, video and/or film footage.

The present invention also has particular applicability in the field of spatially dependent functions. In this example, the original data matrix D is a set of spatially dependent functions, matrix F is a fixed set of spatially dependent functions, and matrix A is a distribution of the fixed spatially dependent functions within the data matrix D. A spatially dependent function may be an image.

In preferred embodiments, the original data matrix D may be a series of images, matrix F may be a set of unvarying images and A may be a measure of how the images in matrix F are distributed in data matrix D.

In yet another embodiment, the original data matrix D is a set of images acquired at different wavelengths.

In still another embodiment, the original data matrix D is a set of images acquired at different times.

In another embodiment of the invention, at least one pattern is an amount of goods or services. Preferably, the rows of the data matrix D are amounts of goods and services at various times, the rows of matrix F are the patterns of goods and services, and the rows of matrix A are a measure of how the amounts of goods and services are distributed over time.

Further, in yet another embodiment, the rows of the data matrix D are amounts of goods and services at various locations, the rows of matrix F are the patterns of goods and services, and the rows of matrix A are a measure of how the amounts of goods and services are distributed over various locations.

The present invention also has particular applicability in the field of behavioral, sociological and psychological studies wherein one is measuring less quantitative functions, as well as the patterns in paragraphs of words. For example, the data matrix D may be a set of measurements representing behavioral studies, clinical studies, biomedical research studies, or psychodynamic studies. In this process, one must convert any qualitative information into quantitative numerical data, since one is not actually counting when one is collecting the data. For example, a query of “how well did you like the program?” where possible answers are “a lot,” “some,” or “a little,” would need to be converted so that the answers correspond to 1, 2 and 3, respectively. Put another way, the information is helpful in understanding the nature of relationships in different aspects of animal behavior and response, such as behavioral data, biomedical responses, and drug responses.

Essentially, the process of the invention as applied to various systems, can be described as follows.

The invention includes a computer implemented process to identify at least one pattern and its distribution in a set of data for the purpose of interpreting the data, the process comprising (a) representing a set of data by an original data matrix D residing in a storage device, and (b) decomposing the set of data into a set of patterns represented by a matrix F and their distribution represented by a matrix A, wherein the matrix F represents the set of patterns needed to describe the data and the matrix A represents the distribution of the set of patterns within the data matrix D, the decomposing comprising performing a Bayesian-based Monte Carlo calculation using at least the data matrix D to determine the matrices A and F, wherein the matrices A and F reconstruct the data matrix D and are more amenable to analysis than the data matrix D.

In specific embodiments, the process further comprises determining by Monte Carlo sampling the uncertainties of all values in the elements of matrix F and matrix A.

In other specific embodiments, the decomposing is performed such that the combined number of the elements in the matrices A and F are significantly smaller than the number of elements of the original data matrix, and the uncertainties in the matrices A and F combine to yield the correct uncertainty in matrix D, the significantly smaller number of elements making the matrices A and F more amenable to analysis than the data matrix D. In addition, a statistical process may be used to determine the number of independent patterns required to reconstruct the original data matrix D within a noise level from the subordinate matrices A and F.

With respect to applications, the independent patterns may be spectral shapes, and further, the statistical process is principal component analysis. In this instance, the process further comprises using the principal component analysis to correct for any instrumental frequency or phase shifts which appear in spectra of the original data matrix D.

It is well within the skill of the artisan to be able to generate data in the form of spectral shapes for analysis using the method of the present invention. In light of this, methods for the generation of data in the form of spectral shapes are not described in detail herein.

In another specific embodiment, rows of the original data matrix D are chemical shift imaging spectra associated with specific locations in a living organism, rows of matrix F are individual nuclear magnetic resonance (NMR) spectra associated with different tissue types, and rows of matrix A are amounts of each tissue type at each specific location within the living organism.

In yet another specific embodiment, rows of the original data matrix D are NMR spectra associated with specific time points during an observation of a living organism, rows of matrix F are individual NMR spectra associated with different chemical species, and rows of matrix A are amounts of each chemical species at each time point.

In another embodiment, rows of the original data matrix D are NMR recovery curves associated with specific locations within a living organism, rows of matrix F are individual NMR recovery curves associated with different tissue types, and rows of matrix A are amounts of each tissue type at each specific location within the living organism.

The generation of chemical shift spectra and NMR spectra is described in detail herein in Example 1.

The applicability of the present invention to the field of biotechnology, for example, but without limitation, the field of genomics and gene chip array analysis is now described. It must be emphasized that this area is exemplified in the present discussion as an area which is ripe for the present analysis. However, exemplification of this area should in no way be construed as limiting the application of the invention solely to this field. As described herein, the present invention is applicable to any area wherein large amounts of data can be analyzed and reduced to meaningful entities.

With respect to the field of biotechnology, the present invention includes a computer implemented process to identify at least one pattern and its distribution in a set of data for the purpose of interpreting the data, the process comprising (a) representing a set of data by an original data matrix D residing in a storage device, and (b) decomposing the set of data into a set of patterns represented by a matrix F and their distribution represented by a matrix A, wherein the matrix F represents the set of patterns needed to describe the data and the matrix A represents the distribution of the set of patterns within the data matrix D, the decomposing comprising performing a Bayesian-based Monte Carlo calculation using at least the data matrix D to determine the matrices A and F, wherein the matrices A and F reconstruct the data matrix D and are more amenable to analysis than the data matrix D. In one embodiment, the rows of the original data matrix D are levels of expression of individual messenger RNA (mRNA) species at specific times, rows of matrix F are patterns of physiologically related mRNA expression, and rows of matrix A are amounts of each expression pattern at each specific point in time.

Specific embodiments of the biotechnology related aspects of the invention include the following. The mRNA levels may be measured by adding a detectable label to DNA derived from the mRNA and then quantitating the amount of label associated with the DNA as a measure of the mRNA levels. The label may be a radioactive label or a non-radioactive label. One skilled in the art may easily decide on a label by reading, for example, Sambrook et al. (1989, Molecular Cloning: A Laboratory Manual, Cold Spring Harbor Laboratory, New York), Ausubel et al. (1997, Current Protocols in Molecular Biology, John Wiley & Sons, New York), or Gerhardt et al. (eds., 1994, Methods for General and Molecular Bacteriology, American Society for Microbiology, Washington, D.C.). The expression of the mRNA may also be measured by synthesizing a DNA molecule which is complementary to the mRNA and detecting the amount of DNA synthesized. Specifically, the DNA molecule may be synthesized in a reverse transcriptase reaction. Alternatively, the amount of DNA synthesized may be measured by adding a detectable label to the DNA, and quantitating the amount of label associated with the DNA as a measure of the amount of DNA synthesized. Again, the label may be a radioactive label or a non-radioactive label. The expression of the mRNA may also be measured by amplifying the mRNA to DNA and detecting the amount of DNA so amplified. In a preferred embodiment, the amplifying may be conducted in a polymerase chain reaction. The mRNA levels may also be measured using an array which may be a high density gene chip array or a low density array. When the array is a low density array, the array is a filter or a plate array.

The invention also includes a computer implemented process as described above, wherein the rows of the original data matrix D are levels of expression of individual messenger RNA (mRNA) species at specific locations within a living organism, rows of matrix F are patterns of physiologically related mRNA expression, and rows of matrix A are amounts of each expression pattern at each specific location in the organism.

The invention further includes a computer implemented process as described above, wherein the rows of the original data matrix D are amounts of individual DNA species in specific individuals, rows of matrix F are patterns of physiologically related DNA species, and rows of matrix A are amounts of each DNA pattern in each individual.

In specific embodiments of this aspect of the invention, the amount of DNA is measured by hybridizing to the DNA a complementary DNA having a detectable label attached thereto and measuring the amount of label so hybridized as a measure of the amount of DNA. The label may be a radioactive or a non-radioactive label. In a preferred embodiment, the amount of individual DNA may be measured by synthesizing a DNA copy of the DNA to generate a synthesized DNA, wherein the synthesized DNA has a detectable label attached thereto and measuring the amount of label in the synthesized DNA as a measure of the amount of DNA. Again, the label may be a radioactive label or a non-radioactive label. This method may further comprise measuring the amount of DNA (non-amplified DNA) by amplifying the DNA (amplified DNA) in the presence of a detectable label, and measuring the amount of label associated with the amplified DNA as a measure of the amount of non-amplified DNA. The amplifying is conducted by a polymerase chain reaction and the amount of individual DNA is measured on an array. The array may be a high density gene chip array or a low density array. When the array is a low density array, the array is a filter or a plate array.

The invention further includes a computer implemented process as described above, wherein the rows of the original data matrix D are amounts of individual DNA species at specific locations in a living organism, rows of matrix F are patterns of physiologically related DNA species, and rows of matrix A are amounts of each DNA pattern at each specific location in the organism. The DNA is measured as described previously.

The invention additionally includes a computer implemented process as described above, wherein the rows of the original data matrix D are amounts of individual DNA species at different times in a living organism, rows of matrix F are patterns of physiologically related DNA species, and rows of matrix A are amounts of each expression pattern at each specific point in time. Again, the DNA is measured as described previously herein.

The generation of data which comprises the structural content or expression of nucleic acid molecules is described in detail herein in the Examples and is therefore not repeated in this section of the application. However, it is important to note that it is not necessary to empirically generate the data for analysis in the process of the invention; rather, there are a vast number of databases which comprise genetic information which may be analyzed using the process of the present invention, in the absence of generating the data empirically.

Within the context of the present invention, certain terms have the meaning ascribed to them herein as follows:

The articles “a” and “an” are used herein to refer to one or to more than one (i.e. to at least one) of the grammatical object of the article. By way of example, “an element” means one element or more than one element.

“Amplification” refers to any means by which a polynucleotide sequence is copied and thus expanded into a larger number of polynucleotide molecules, e.g., by reverse transcription, polymerase chain reaction, and ligase chain reaction.

“Apoptosis” means a process by which a cell undergoes the process of programmed cell death.

“Complementary” as used herein refers to the broad concept of subunit sequence complementarity between two nucleic acids, e.g., two DNA molecules. When a nucleotide position in both of the molecules is occupied by nucleotides normally capable of base pairing with each other, then the nucleic acids are considered to be complementary to each other at this position. Thus, two nucleic acids are complementary to each other when a substantial number (at least 50%) of corresponding positions in each of the molecules are occupied by nucleotides which normally base pair with each other (e.g., A:T and G:C nucleotide pairs).

By the term “physiologically related DNA or mRNA” is meant a DNA or mRNA species which encode proteins having related biological functions. By way of example, but without limitation, a DNA or an mRNA species which encodes a particular protein and DNA or an mRNA which encodes an isoform of the same protein can be considered to be physiologically related to each other.

“Encoding” refers to the inherent property of specific sequences of nucleotides in a polynucleotide, such as a gene, a cDNA, or an mRNA, to serve as templates for synthesis of other polymers and macromolecules in biological processes having either a defined sequence of nucleotides (i.e., rRNA, tRNA and mRNA) or a defined sequence of amino acids and the biological properties resulting therefrom. Thus, a gene encodes a protein if transcription and translation of mRNA corresponding to that gene produces the protein in a cell or other biological system. Both the coding strand, the nucleotide sequence of which is identical to the mRNA sequence and is * usually provided in sequence listings, and the non-coding strand, used as the template for transcription of a gene or cDNA, can be referred to as encoding the protein or other product of that gene or cDNA.

Complementary DNA copies of mRNA are produced using “reverse transcriptase.”

“Amplification” refers to any means by which a polynucleotide sequence is copied and thus expanded into a larger number of polynucleotide molecules, e.g., by reverse transcription, polymerase chain reaction, and ligase chain reaction.

With respect to additional applications of the invention, there is included the process described above, wherein are measurements of individual samples comprising mixtures of chemical compounds, rows of matrix F are the measurements associated with a single chemical compound, and rows of matrix A are amounts of each chemical compound in each of the individual samples. Specifically, the rows of the data matrix D may be gas chromatography/mass spectra (GCMS) measurements, and the rows of matrix F are then the GCMS spectra for the individual chemical compounds. In another embodiment, the rows of the data matrix D are infrared spectroscopy measurements, and the rows of matrix F are the infrared spectra for the individual chemical compounds. In yet another embodiment, the rows of the data matrix D are optical absorption spectroscopy measurements, and the rows of matrix F are the optical absorption spectra for the individual chemical compounds. Alternatively, the rows of the data matrix D are fluorescence spectroscopy measurements, and the rows of matrix F are the fluorescence spectra for the individual chemical compounds. In a further embodiment, the rows of the data matrix D are high pressure liquid chromatography/standard detection measurements, and the rows of matrix F are the spectra for the individual chemical compounds, wherein the spectra are selected from the group consisting of GCMS spectra, infrared spectra, optical absorption spectra and fluorescence spectra.

It should be apparent from the disclosure provided herein that the manner in which the chemical data are generated is irrelevant to the use of the process of the invention for analysis of the data. That is, the skilled artisan in the field of chemical analysis may, without effort, generate the necessary data, or choose the necessary data from an available source for analysis in the present process. Thus, the invention should in no way be construed to be limited to the manner in which any chemical data are acquired, but rather should be construed to include the analysis of any chemical data, irrespective of the mechanism used for the acquisition thereof.

As noted above, additional applications of the present invention include analysis wherein at least one pattern comprises a monetary value, an amount of goods or services, wherein the pattern distribution is across entities, wherein the pattern distribution is across a space or a location, wherein the pattern distribution is across time, wherein representing a set of data by an original data matrix D involves counting a number of occurrences of events within the set of data and encoding the number of occurrences into the original data matrix D, wherein the original data matrix D is a set of spatially dependent functions, matrix F is a fixed set of spatially dependent functions, and matrix A is a distribution of the fixed spatially dependent functions within the data matrix D, wherein the data matrix D is a set of measurements representing behavioral studies, the data matrix D is a set of measurements representing clinical studies, wherein the data matrix D is a set of measurements representing biomedical research studies, or wherein the data matrix D is a set of measurements representing psychodynamic studies.

### EXAMPLES

The invention is now described with reference to the following examples. These examples are provided for the purpose of illustration only and the invention should in no way be construed as being limited to these examples but rather should be construed to encompass any and all variations which become evident as a result of the teaching provided herein.

### Example 1

Application of the Method of the Invention to Chemical Shift Images

A frequent problem in analysis is the need to find two matrices, closely related to the underlying measurement process, which when multiplied together reproduce the matrix of data points. Such problems arise throughout science, for example in imaging where both the calibration of the sensor and the true scene may be unknown and in localized spectroscopy where multiple components may be present in varying amounts in any spectrum. Since both matrices are unknown, such a decomposition is a bilinear problem. A solution to this problem is provided in the present example, for the case in which the decomposition results in matrices with elements drawn from positive additive distributions. The power of the methodology is demonstrated on chemical shift images (CSI). The method of the invention reduces the CSI data to a small number of basis spectra together with their localized amplitudes. This method has been applied herein to a ¹⁹F nonlocalized study of the catabolism of 5-Fluorouracil in human liver, ³¹P CSI studies of a human head and calf muscle, and simulations which illustrate its strengths and limitations. In all cases, the dataset, viewed as a matrix with rows containing the individual NMR spectra, results from the multiplication of a matrix of generally nonorthogonal basis spectra (the spectral matrix) by a matrix of the amplitudes of each basis spectrum in the individual voxels (the amplitude matrix). The results demonstrate that the method of the invention can simultaneously determine both the basis spectra and their distribution. The method can solve this bilinear problem for any dataset which results from multiplication of matrices derived from positive additive distributions if the data overdetermine the solutions.

A common need in the analysis of the large datasets found in CSI and many other fields is the reduction of the very large amount of information contained in the data to a manageable size. For example, in a CSI examination 512 spectra of 512 points are usually acquired. While many of these spectra contain nothing but noise, typically there are still hundreds of spectra to analyze. These spectra are rarely completely independent of one another but rather are a mixture of a handful of spectra coming from different tissue types making varying contributions to individual voxels. The problem is to determine how the CSI dataset can be decomposed into the spatial distributions of the spectra of the different tissue types. Since neither the spectra nor their spatial distributions are known, a bilinear problem must be solved in order to determine them simultaneously. Most traditional methods of data analysis (e.g., standard methods of matrix decomposition, Fourier transformation, least squares fitting) cannot decompose the data in this way but simply estimate the individual spectra (or their properties) in each voxel with no attempt to determine their interrelationship.

In a general bilinear problem, the data matrix, D, can be considered as a series of M vectors taken from R^{N}, yielding an M×N matrix. The problem is to obtain both the matrix of K (K<<M, N) often nonorthogonal, basis vectors, F (K×N) (here the spectral shapes), and a mixing matrix, A (M×K), which gives the amount of each basis vector in the actual data. The data is then related to the model through a matrix multiplication,

D=AF. [1]

This is similar to a standard “inverse” problem except that in the “inverse” case one of the matrices is known and thus least square methods can be used to find the matrix which minimizes the residuals between the reconstruction and the data. With neither A nor F known (even if K is only two or three), the problem is much more difficult Since the number of possible solutions is very large and there is no analytical method to identify them, the Markov chain Monte Carlo procedure (MCMC) was used to sample the space of possible solutions to determine its properties. MCMC is a technique derived from statistical mechanics, where it has been used for over 50 years to explore the solution spaces associated with distributions of interacting molecules or spins. Since MCMC algorithms directly sample the solution space, uncertainty estimates are determined simultaneously with a “best” solution. Further, if the data support them, multiple solutions are possible. Their application to stochastic image processes was initially demonstrated by Geman and Geman(1984, IEEE Trans. on Pattern Analysis and Machine Intelligence 6:721-741), leading to exploration of a wide variety of sampling procedures(Hastings, 1970, Biometrika 57:97-109; Metropolis et al., 1953, J. Chem. Physics 21:1087-1091; Kirkpatrick et al., 1983, Science 220:671-680) for solution of imaging problems, reviewed by Besag et al. (1995, Statist. Science 10:3-66).

MCMC techniques require relative probability measurements at each sampled point in the solution space, which is provided herein through a Bayesian approach. In the past decade Bayesian methods using MCMC techniques have been used in a wide variety of problems in data analysis, e.g. medical imaging, agricultural field studies, population studies, and economic forecasting (Besag Green, 1993, J. R. Statist. Soc. B 55, 25-37; Grenander and Miller, 1994, J. R Statist. Soc. B 56, 549-603; Besag, 1986, J. R. Statist. Soc. B 48, 259-302; Hill, 1994, Econometric Theory 10:483-513; Marseille, et al.,1996, Bayesian estimation of MR images from incomplete raw data, in “Maximum Entropy and Bayesian Methods” (J3 Skilling and S. Sibisi, Eds.), pp. 13-24, Kluwer, Dortrecht). Bayesian statistical analysis starts with the apparently trivial statement,

P(M,D)=p(M\D)p(D)=p(D\M)p(M) [2]

where p(M,D) is the probability of both the model and the data (the joint probability distribution), p(M\D) is the conditional probability of the model given the data (the posterior), p(D) is the probability of the data (the evidence), p(D\M) is the conditional probability of the data given the model (the likelihood), and p(M) is the probability of the model (the prior). The posterior distribution is the solution space for the problem, since it measures the probability of the present model (sample) in light of the data. Rearrangement of Eq. [2] yields the posterior,

p(M\D)=p(D\M)p(M)\p(D) [3]

which provides the MCMC algorithm with the needed probabilities in the solution space for the problem. Since the evidence, p(D), usually acts as a scaling parameter, it can be ignored in this case as MCMC only needs relative probabilities. This means that the relative probability at a point in the solution space is determined completely by the likelihood, which is easily determined by comparing the model to the data, and the prior, which is the probability of the model independent of the data. The prior encodes any knowledge of the solution independent of the data. For example, a prior for a system reconstructing spectra might give higher probability to a narrow spike than to a flat offset.

Putting in the matrices A and F for the model leads to the specific form of Bayes' equation (Eq. [3]) for the bilinear problem,

P(A,F\D)∞p(D\A,F)p(A,F). [4]

The sampling from the posterior distribution and the encoding of the prior are done using a heavily modified version of the Massive Inference™ Gibbs sampler from MaxEnt Solutions Ltd., Cambridge, England, which also enforces positivity on the solutions. The primary modifications revolve around how the likelihood changes as the MCMC samples the solution space. The original Massive Inference™ system handled systems where A in Eq. [1] is a known constant matrix, which makes the change in the likelihood dependent only on a change in F. δF. When A is treated as a variable matrix on the same footing as F, the calculations of the change in the likelihood with a change in flux in either A or F requires that the other matrix be constantly updated, which is discussed in detail below.

Since the method in this example is used to reconstruct spectral shapes (known to contain fairly sharp lines) and spatial distributions (essentially images), the atomic prior from Massive Inference™ is appropriate. An atomic prior -represents the model as a few point fluxes (atoms) with the highest probability assigned to the distribution with the fewest atoms. It contains only two adjustable parameters, the average strength (flux) of the atoms and the probability of finding an atom. Both are adjusted by the program to match the data. This prior follows naturally from general divisibility arguments (Sibisi Skiliing, 1,997, J. R. Statist. Soc. B 59, 217-235), and thus is widely applicable. For example, it should also be effective in describing systems where the signals arise from discrete objects (e.g. photons striking a photographic plate, nuclei undergoing spin flips).

Once the prior is chosen the remainder of the problem is straightforward, although a number of features have been added to the method of the invention to improve efficiency. The method starts the Markov chain at a point in the posterior distribution representing a completely flat model containing a reconstructed flux equal to the flux in the data In this way the sampler starts nearer the region of high probability while avoiding any initial bias on expected spectral shapes or distributions. The likelihood is calculated using the sum of the squares of the residuals normalized by the standard deviation, a, of the noise in the spectral data, ie. a normalized χ²distribution. Rather than perform a full likelihood calculation for each movement of the Markov chain, the change in the likelihood is calculated for the specific change in the model, so that the likelihood can be updated incrementally. The likelihood, L, can be written in matrix notation as

$$L = \frac{1}{2 {σ}^{2}} Tr [ {( AF - D )}^{T} ( AF - D ) ] \qquad [ 5 ]$$

where A^{T} represents the transpose of A and Tr indicates the trace of the quantity in the brackets. Then the behavior of the change in the likelihood, ΔL, can be derived by looking at the effect of adding a small amount of flux, δF, to the model. By inserting F+δF for F in Eq. [5] and subtracting Eq. [5] from the result, the change in likelihood for a change in F is

$$Δ L ( δ F ) = \frac{1}{2 {σ}^{2}} Tr [ \begin{matrix}{( A δ F )}^{T} ( AF - D ) + \\ {( AF - D )}^{T} A δ F + {( A δ F )}^{T} ( A δ F )\end{matrix} ] \qquad [ 6 ]$$

where it is assumed that only changes to F are made. The coding is made more efficient by maintaining a mismatch vector which measures the misfit between the data and the reconstruction from-the model, i.e.

M=D−AF. [7]

A great increase in calculational efficiency is gained by updating the mismatch vector incrementally after each Markov step just as the likelihood is incremented. For added flux δF, M changes by

ΔM=D−AδF [8]

where only the affected components of M must be updated. Eqs. [6] and [8] have similar forms for changes in the model for A. In order to simplify the calculations, simultaneous changes in A and F are not allowed, since allowing such changes would require evaluation of terms involving δAbF. Note that barring such changes does not prevent the system from reaching any state and should have no effect on the final result, since the sampler can move δF followed by δA and reach the same point. As long as detailed balance is maintained, the sampler still samples. the space correctly. At each step of the Markov chain, the program calculates the change in the likelihood using Eq. [6] and determines whether to move by comparing this with a randomly generated value. If the step is taken, the likelihood and the mismatch vector are updated. MCMC samplers require a “bum-in” time to reach an area of high probability which is suitable for sampling. The sampler runs for an operator-specified time without recording samples and then continues while recording for a further number of steps specified by the operator.

A final modification was made in the method of the invention in order to more fully represent the physical world in the models. Atoms in F are given a Gaussian lineshape with a width defined by the operator, which is generally the natural width of the problem, usually directly measurable from the narrowest line in. the spectrum. For the mixing matrix, A, a priori knowledge of the absence of material is sometimes available, so the operator also has the option of specifying a certain number of zeros in one solution component in the A matrix. For strongly overlapping spectra, especially when a single line is dominate in one of the underlying spectra, as in the CSI study of the human head presented below, it greatly improves efficiency to add such a priori knowledge of the distribution of signals.

The operation of the method of the invention on CSI-and multispectral datasets is straightforward. First, Principal Component Analysis (PCA) is used to correct the data for instrumentally induced frequency and phase shifts as described previously (Stoyanova et al., 1995, J. Magn. Reson. A 115:265-269; Brown and Stoyanova, 1996, J. Magn. Reson. 112:3243). PCA is then applied to the corrected data to determine the number of independent spectral shapes, K in Eq. [1], needed in the model to reconstruct the data. Generally it is obvious from the PCA results how many independent shapes are present in the data. However if-there is any uncertainty, the method can be run with several different K values. The data, the number of shapes, the standard deviation of the noise, and the linewidth are fed into the method of the invention together with the number of iterations desired. These are the only inputs that the method requires to operate. During sampling, the method is free to exchange flux between the A and F domains, so the individual samples are scaled prior to averaging. The method is generally run using several different Markov chains in order to verify the results, as MCMC techniques have no established convergence criteria Since the method samples the solution space, the output includes not only a mean solution but also uncertainty estimates at each spectral point as well as at each amplitude in the mixing matrix. If there are multiple possible solutions, the method will find these as well. The power of the method is demonstrated on a series of increasingly complex datasets in the results which are now described below.

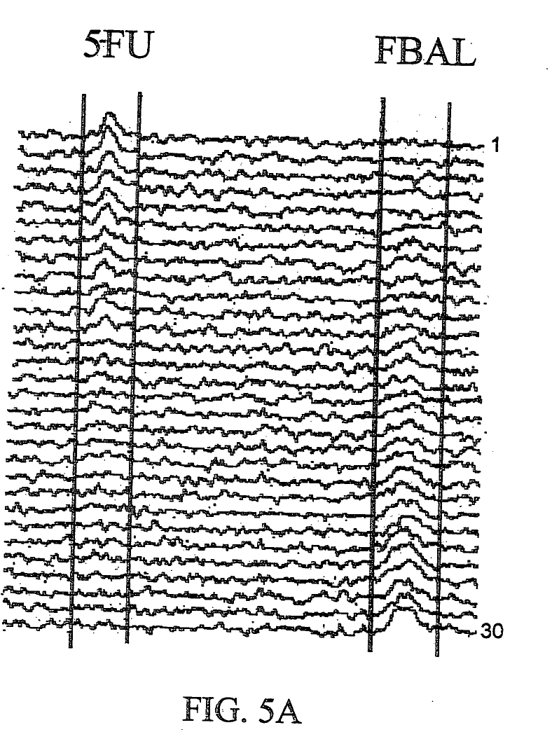

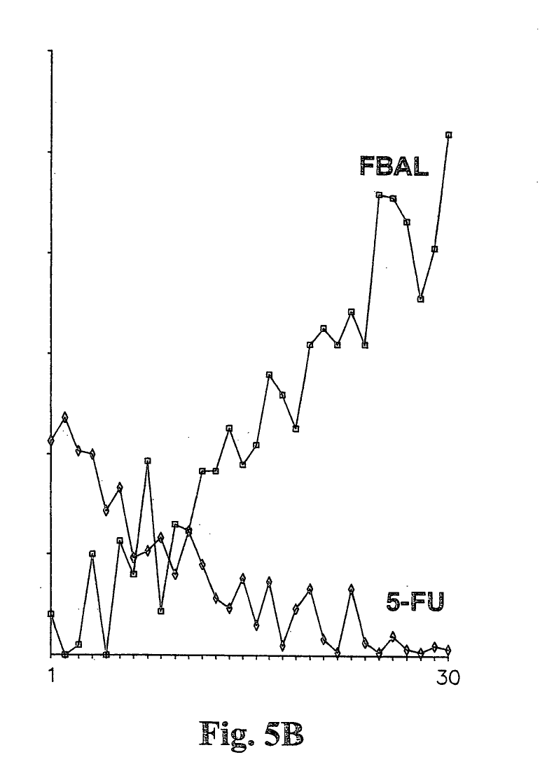

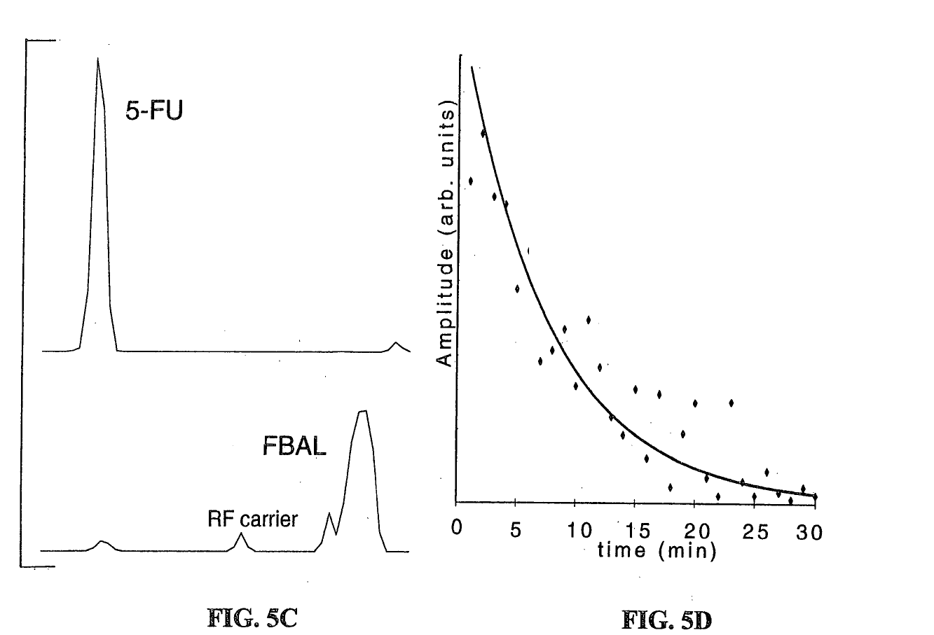

A straightforward example of the operation of the method is presented in FIG. 5 illustrating data from a study of the catabolism of 5-fluorouracil (5-FU to α-fluoro-β-alanine (FBAL) in human liver during chemotherapeutic treatment (Li et al., 1996, Clin. Canc. Res. 2: 339-345). PCA was used to remove small frequency offsets in the individual spectra (FIG. 5a) and to determine that two orthogonal components adequately described the data. The method searched for two spectral shapes. These shapes and their amplitudes are shown in FIGS. 5b and 5c. Repeating the analysis with four different seeds and thus four different Markov chains generated identical results (not shown). Note that the fluctuations in amplitude in FIG. 5b are not due to the MCMC procedure but reflect the actual variations in the data in FIG. 5a. The time constant of the exponential fit shown in FIG. 5d is 7.61^{+1.90}_{-1.27} minutes (95% confidence levels) for the decline of 5-FU, in agreement with previously published results obtained using PCA (Li et al., 1996, Clin. Canc. Res. 2: 339-345). Increasing the sampling to 20,000 points did not change the result, demonstrating that the sampling had achieved equilibrium. Note that while the previous analysis by Li et al. (supra) required ad hoc transformation of the PCA components to reconstruct the 5-FU and FBAL spectra, these spectral shapes were determined automatically in the method of the invention. The reconstructed spectral shapes clearly illustrate the power of the atomic prior, which encourages noise in the spectra to be reduced to the baseline, while maintaining features which are slightly above the noise. The small peak on the shoulder of FBAL in FIG. 5c can be seen in the data in FIG. 5a, however a dataset with better SNR would be required-to confirm its presence.

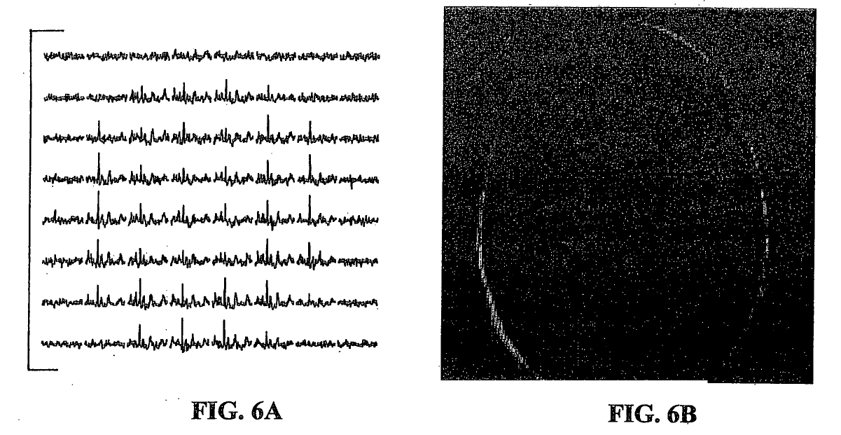

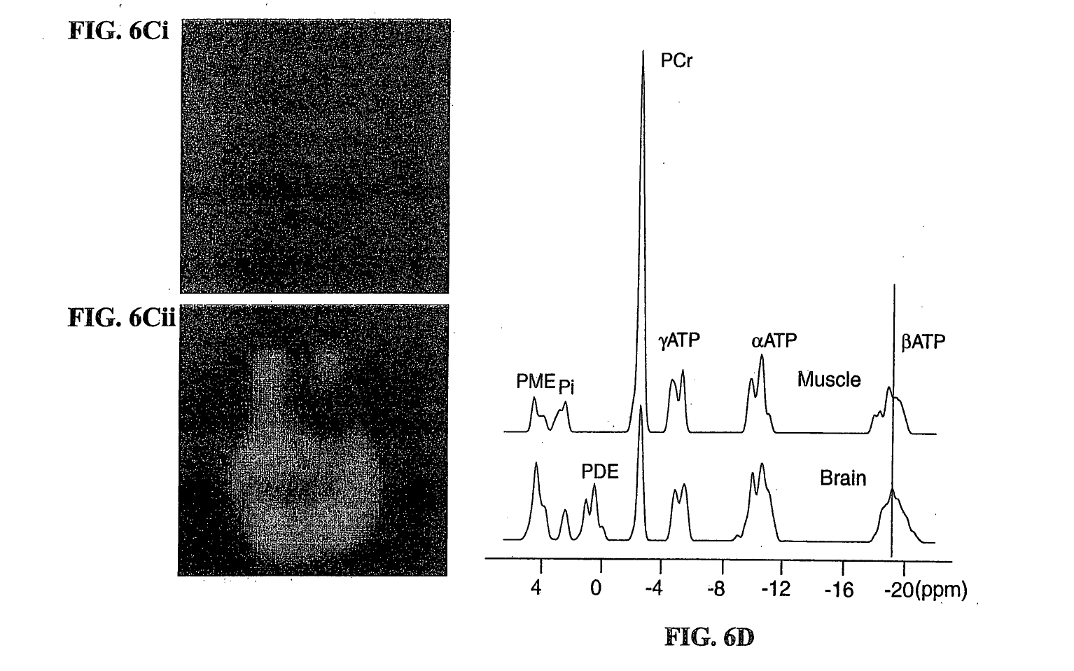

A more complex decomposition problem is shown in FIG. 6. This is a dataset comprising 256 ¹H decoupled ³¹P spectra of typical peak signal to noise ratio (SNR) of approximately six. These spectra were selected by choosing axial slices with signal from 512 spectra (8×8×8 voxels) obtained by spatial and time FFT of CS1 data acquired from a volunteer's head as described elsewhere (Murphy-Boesch et al., 1993, NMR Biomed 6:173-180). The low SNR of the spectra (typical for such studies), 64 of which are shown in FIG. 6a together with the corresponding proton image in FIG. 6b, make it virtually impossible to study individual peaks. PCA was again used to align the spectra on the PCr peak. The PCA analysis determined that two components adequately described the dataset so the method was run looking for two spectral shapes and their distributions. FIG. 6c depicts the resulting reconstructed amplitude distributions on the same scale for comparison, while FIG. 6d illustrates the underlying spectral shapes, which were reconstructed using Gaussian lineshapes with widths of 5.7 points. The reconstructed spectral shapes are clearly identifiable as characteristic of muscle tissue and of brain tissue. The brain spectrum illustrates large phosphodiester and phosphomonoester (PME) peaks, the expected broad PATP resonance arising from exchange between free and ATP-bound magnesium, and the typical βATP frequency shift indicating a lower free Mg²⁺ concentration than in muscle (Taylor et al., 1991, Proc. Natl. Acad. Sci. USA 88:6810-6814). The amplitudes show the muscle localized on the edge of the skull and at the occipital lobes as expected, while the brain is internal to the muscle signal. Since the reconstructed spectra result from fitting the model to 256 data spectra, there is a dramatic improvement in the SNR over the unprocessed data.

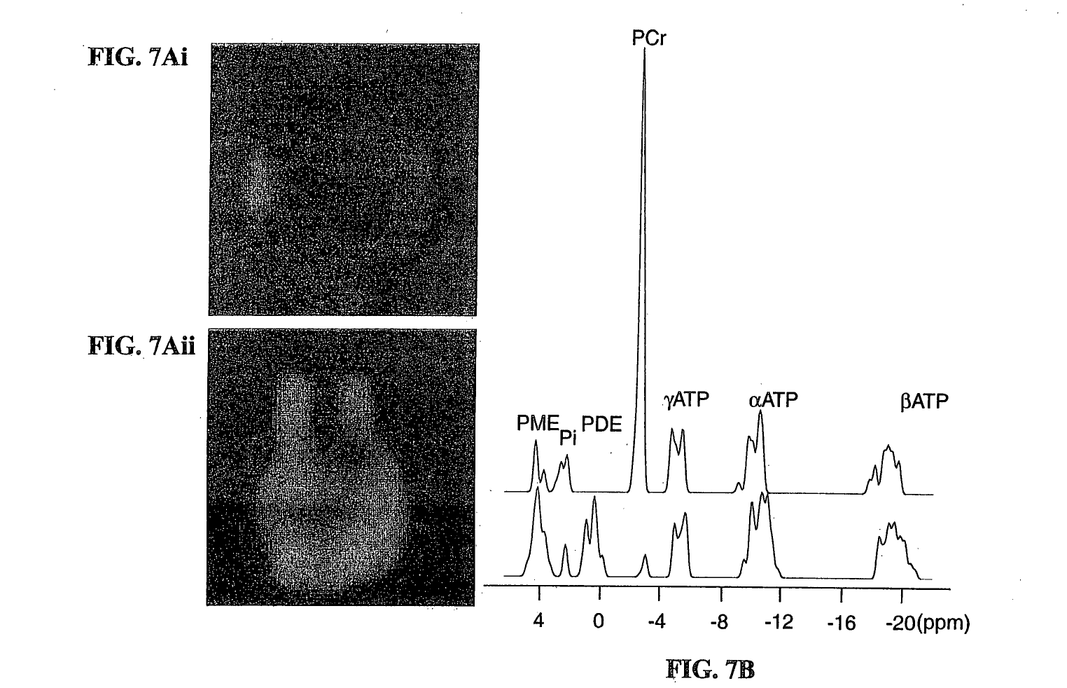

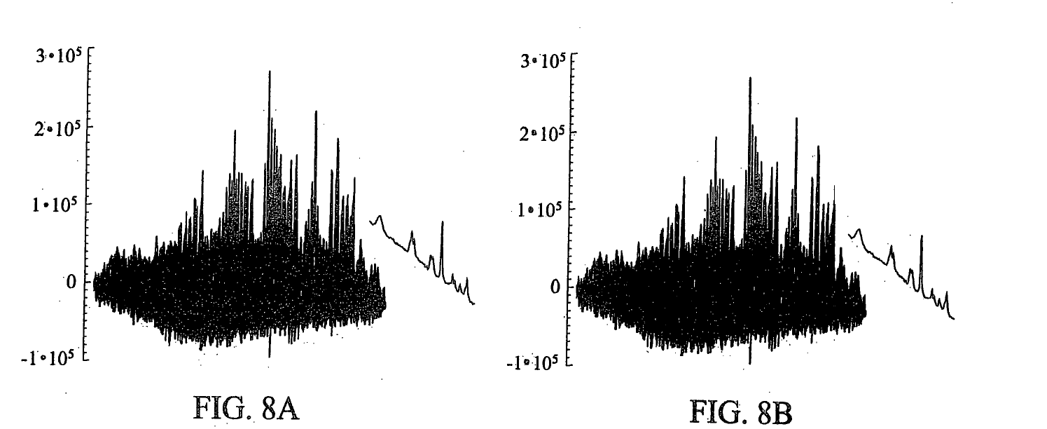

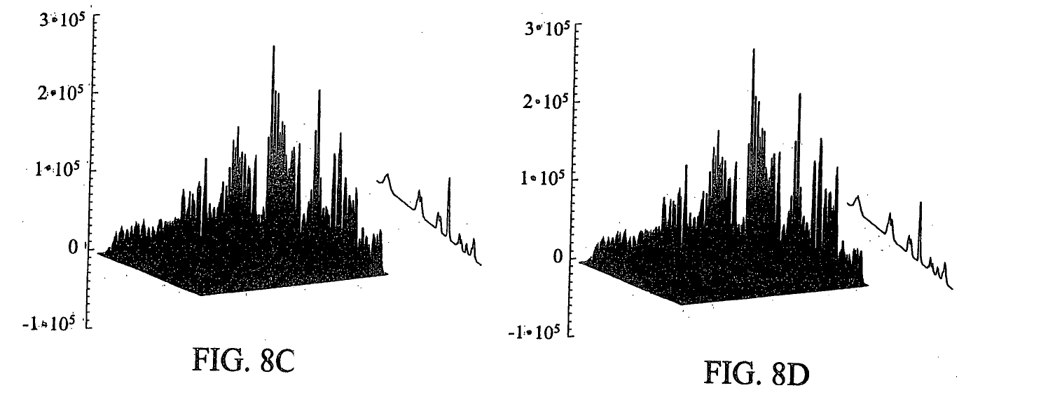

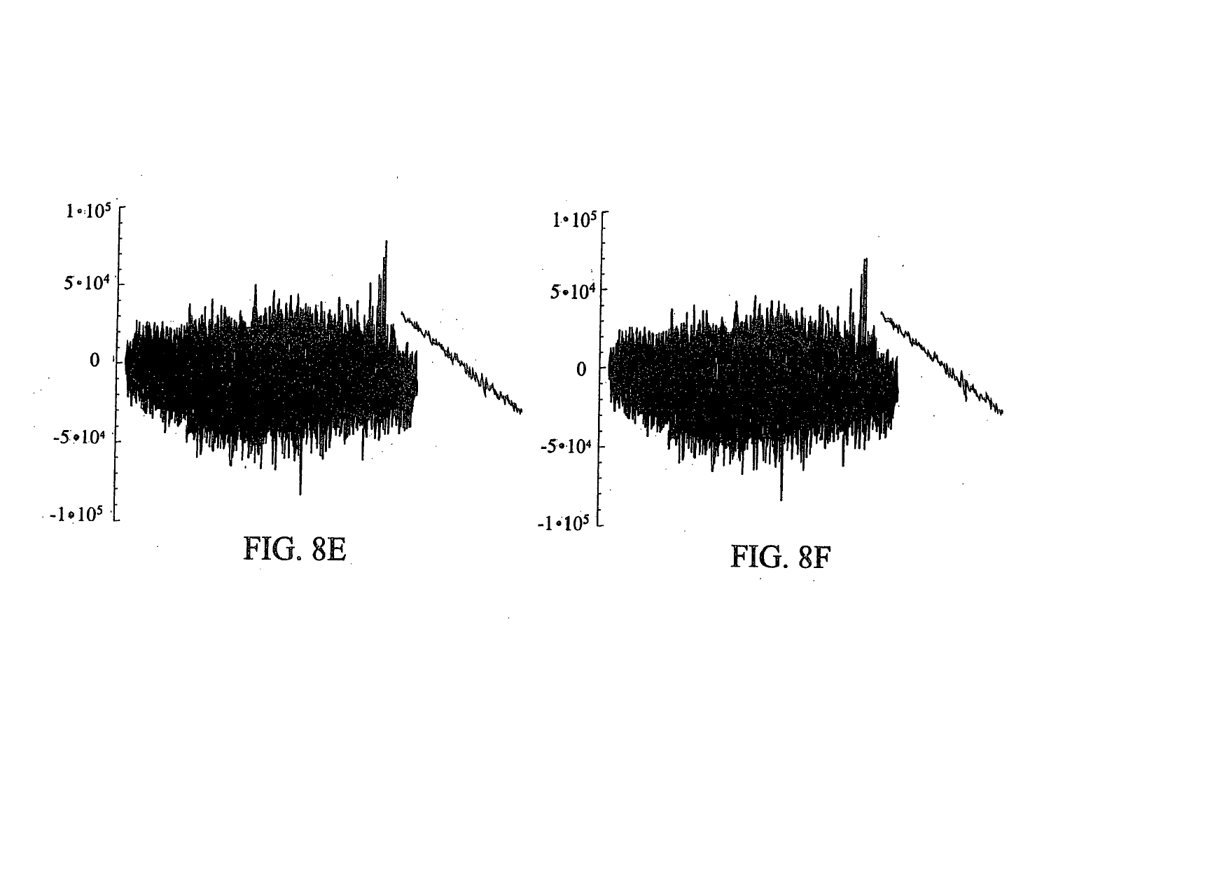

This case demonstrates some of the complexity of this procedure since the solution in FIG. 6 was only one of the possible solutions found using the method of the invention. This solution resulted when 12 zeros were set in the amplitude of one spectral shape deep inside the head, which had the effect of forcing that region to be represented by only the “brain” spectral shape. In addition to this solution, the method found solutions with a “brain” spectrum with either half or almost no PCr when run with no forced zeros. The fit to the data was preserved by adding a fraction (typically 10%) of the “muscle” spectral shape into the brain region (see FIG. 7 for an extreme example). In fact, FIG. 8 depicts plots of the data, reconstructions from the models, and residuals for both cases. There is no perceivable difference in the residuals indicating that there is no support for one solution over the other in the data itself. Since the method samples the solution space directly, it finds such mathematically possible solutions, which can be helpful when the physical situation is not as well determined as here. This second, nonphysical solution could be excluded a posteriori by noting that the brain does not contain muscle tissue or a priori by forcing a solution to have zero amplitude deep in the brain. The a priori approach is computationally more efficient, since it does not require many different Markoy chains to obtain physically significant results. Both analyses on the 256 spectra of 369 points involved sampling of 50,000 points from the posterior distribution following 24,000 iterations to allow equilibration.

In order to explore the meaning of these multiple solutions mote fully, a dataset composed of 100 data spectra of 300 points each with strongly overlapping peaks was generated. Each spectrum in the data was a mixture of three basis spectra, which were modeled on typical muscle spectra containing small pH differences and small J coupling and ATP shift differences. The basis spectra together with their distributions are shown in FIGS. 9a and 9b respectively. The individual basis spectra contain ten spectral lines each with a Gaussian lineshape of width 2.2 points. Random Gaussian noise was then added to each data spectrum at different levels and the method searched for three basis spectra using a number of different Markov chains.

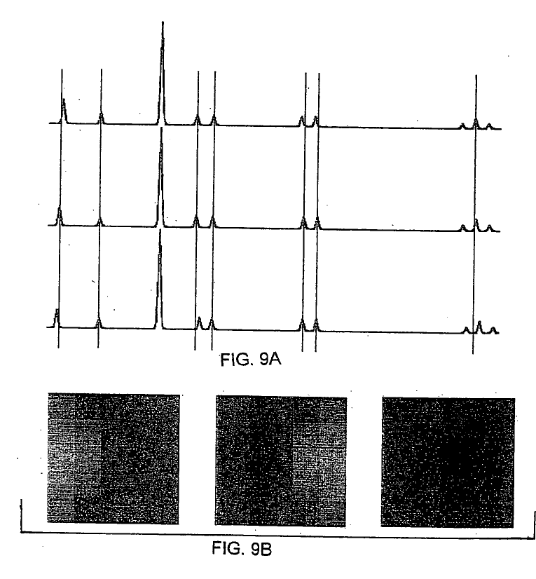

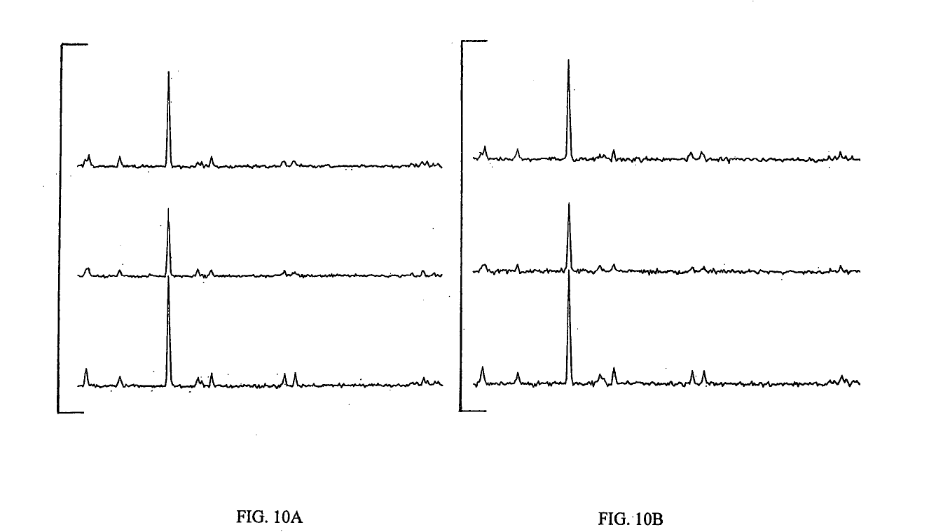

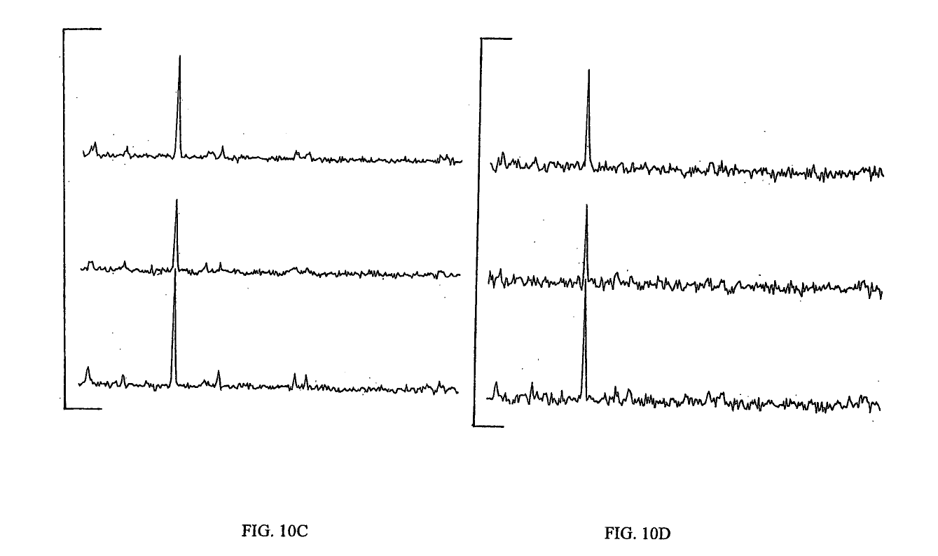

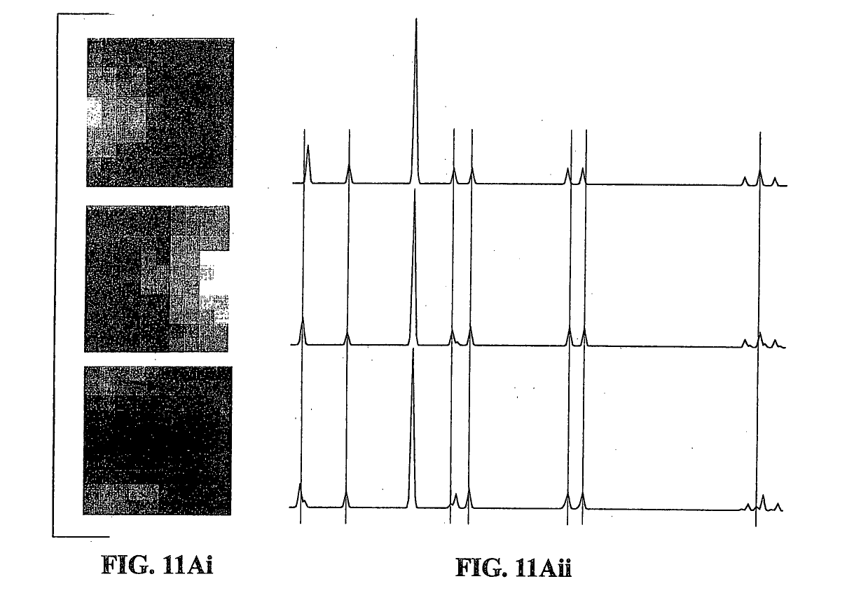

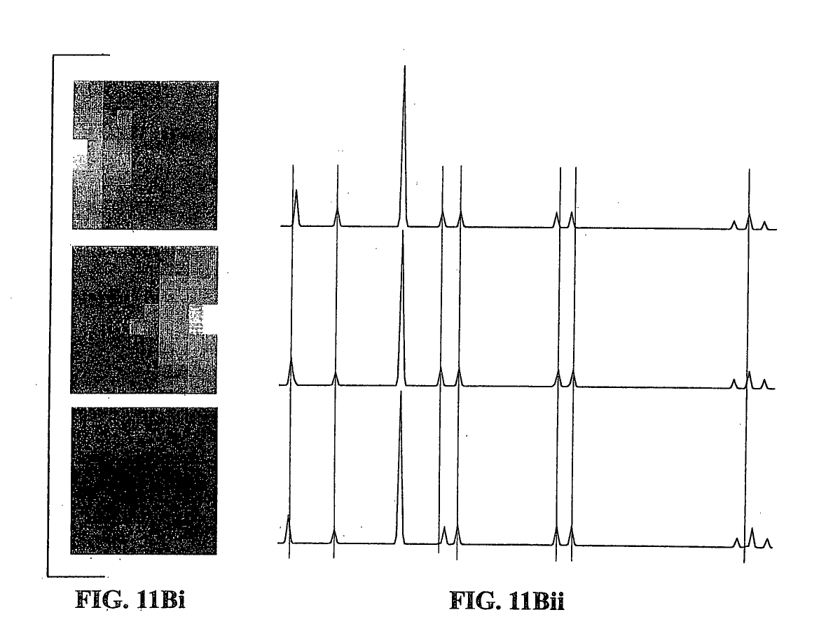

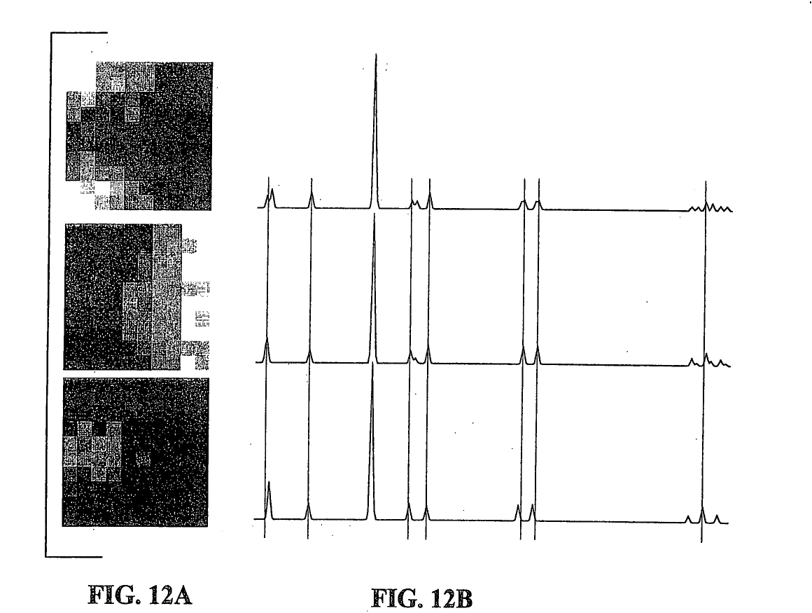

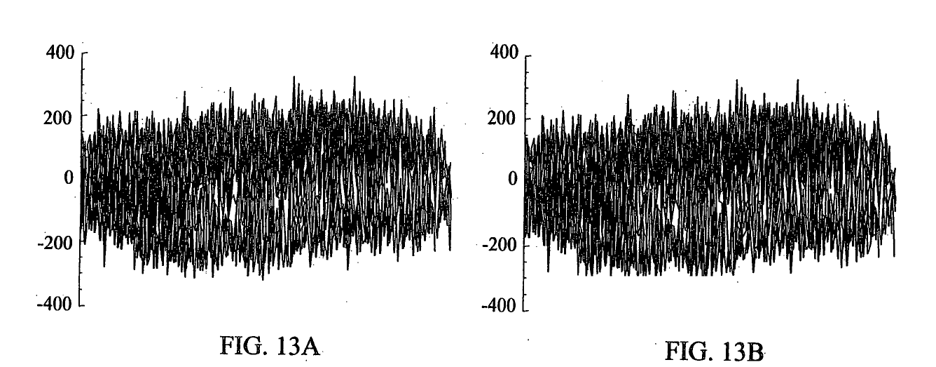

The picture which emerges from these simulations is one where the method reliably finds the expected solution in cases where the SNR is high, but as the noise level increases it finds this solution only part of the time. In FIG. 10, sample spectra of the data for each noise level are shown. The differences between the simulated basis spectral shapes are primarily in the Pi and ATP peaks. The maximum SNRs used in the simulations for these peaks in the data are 8, 6, 4, and 2 for ATP and 16, 12, 8, and 4 for Pi. FIG. 11 illustrates the two solution types found in the case of the highest SNR. As can be seen, they are almost identical. The spectral shapes shown in FIG. 11a have some minor crosstalk between the basis spectra in the AT? regions of the second and third spectra leading to small peaks around the expected larger peaks. The uncertainties calculated by the method for these peaks are roughly half their peak amplitude indicating that -they are not well supported by the data (typical peak uncertainties identified by the method in these spectra are at the 15% level while they are at the 5% level in the FIG. 11b solution). Both solutions (FIGS. 11a and 11b) have the correct larger peaks compared to the true basis spectra with the correct relationships between Pi and ATP shifts and J couplings. As the noise level is increased, the method begins to find other possible solutions. At the second highest noise level, 20% of the time (2 out of 10 Markov chains), the method returns a solution (FIG. 12) which strongly mixes the three basis spectral shapes to form a solution which has fewer atoms (thus a higher prior probability) while having a higher χ² (thus a lower likelihood). The reconstructed model's fit to the data is poorer as measured by a root mean square residual misfit in the amplitudes, which is over two times the size of the correct case. However, as illustrated in FIG. 13, the residuals of the reconstruction compared to the data appear equally uniform. As the noise increases this solution is seen more often, so that at the third level of SNR (ATP maximum SNR of 4), only ⅓ (7 out of 20 Markov chains) of solutions are the correct solution. Finally, in the analysis of the dataset with the lowest SNR, the prior probability dominates the solution space, and the method prefers to fit the data with two basis spectral shapes to reduce the number of atoms. These results reflect the general pattern seen with this method, in which the prior becomes more and more dominant as the information content in the data diminishes.

During sampling, the method also gathers statistical data on the distribution of the possible models, which allows it to give both the mean model and the standard deviations of the points in the model. In the bilinear case, these uncertainties are more complex than for a Markov chain in a linear system. In a bilinear system there is the possibility of correlated uncertainties between the two domains, A and F. In the specific instance described herein, this is compounded by the treatment of an atom in F as a spectral line, which effectively means an atom in F is distributed over many points while an atom in A is not. In order to test the uncertainties the high SNR dataset was run first with the correct linewidth and then with no linewidth (effectively treating each point in the spectra independently). The uncertainties summed over all points in A and F are summarized in Table 1. Here there is a clear better overall fit to the spectra when atoms in F are given a lineshape, but this results in slightly poorer fit in A. Also, the calculated standard deviations show that the sampler is more tightly locked into the spectral shapes when an atom is converted to a linewidth than to a single point (standard deviation of 8.5×10⁻⁵ vs. 1.4×10⁻⁴). This leads to the sampler possibly underestimating uncertainties for the peak heights in the spectral shapes and overestimating them for the amplitudes in the mixing matrix, which indicates that running multiple Markov chains is a better way to estimate uncertainties in the bilinear case.

TABLE 1

| | Amplitude | | | |
|---|---|---|---|---|
| Linewidth | RMS | Amplitude Avg | Spectra RMS | Spectra Avg |
| (points) | Misfit | Std Dev | Misfit | Std Dev |
| 1 | 56 | 564 | 1.79 × 10⁻⁵ | 1.43 × 10⁻⁴ |
| 7 (σ = 1.1) | 66 | 690 | 1.51 × 10⁻⁵ | 8.47 × 10⁻⁵ |

Table 1: the misfit to the known input for the highest SNR simulation averaged over the entire dataset is shown together with the estimates from the method for the standard deviations. The two cases are for an atom with a linewidth of zero (i.e. all flux placed into a single point) and for a Gaussian with a linewidth of 2.2 points with the flux spread over 7 points. The mean amplitude over the dataset is 7754 and the mean spectral peak height is 3.33×10⁻³.

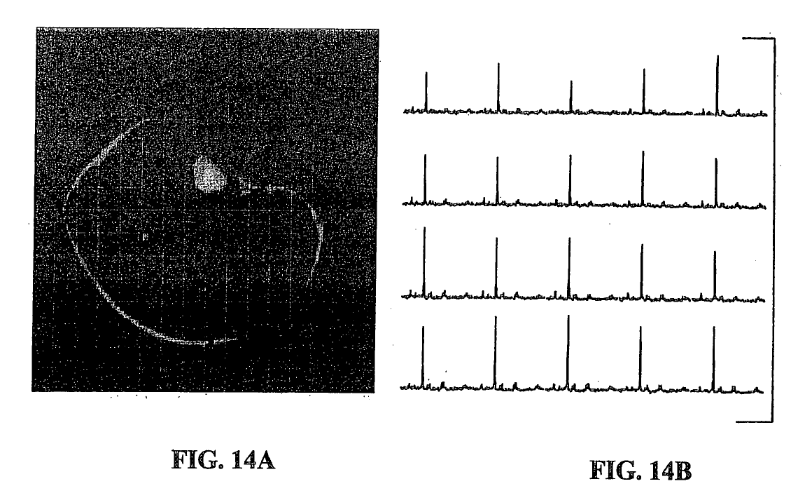

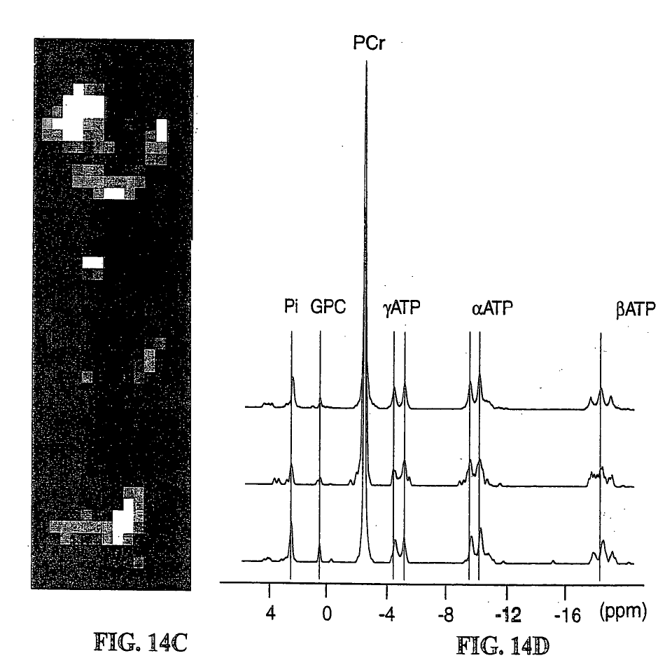

One final example is a CS1 dataset from human calf muscle. The dataset was gathered as a 12×12×8 set, zerofilled, and Fourier transformed to 16×16×8 voxels as described for 8×8×8 datasets previously (Brown et al., 1995, Magn. Reson. Med. 33:417-421). Using the proton image, 156 spectra out of 2048 were selected for being within the leg in the two axial slices showing the largest cross-section of calf muscle in the proton image. PCA was used to align the 156 data spectra on the PCr frequency. Further PCA demonstrated that there were three components in the data with very large frequency overlap among them. In FIG. 14a one of the two axial slices from the calf muscle is shown, with a sample of the ³¹P CS1 data in FIG. 14b. The data are of high SNR, however there are no clear differences between them on initial inspection. FIGS. 14c and 14d contain the results of the method for amplitude distribution and spectral shape respectively. The results are an average of 50,000 samples from the posterior distribution following 25,000 steps of equilibration.

A summary of the differences between the spectra is given in Table 2 and shows that there are three distinct signals arising from the calf muscle. The first and second spectral shapes are similar, except for differences in pH. The third spectral shape shows a smaller γATP splitting due to J coupling and a higher βATP shift. In addition to their spectral differences, the components have different spatial distributions within the calf muscle as shown in FIG. 14c. The third shape is stronger in the posterior of the calf, while the first is stronger in the anterior. The second shape is strongest in a ring along the outer edge of the calf muscle. Initial results on other individuals indicate that the spectral shapes are consistent across individuals while their distributions show some variations. The origin of these differences is not clear; however it seems plausible that they may be due to variations in fiber type between the muscle groups.

TABLE 2

| | Shape 1 | | Shape 2 | | Shape 3 | |
|---|---|---|---|---|---|---|
| γATP J coupling | 18.3 | Hz | 18.6 | Hz | 15.1 | Hz |
| αATP J coupling | 16.1 | Hz | 16.4 | Hz | 15.9 | Hz |
| βATP J coupling | 17.3 | Hz | 17.3 | Hz | 16.0 | Hz |
| γATP Shift | −4.87 | ppm | −4.85 | ppm | −4.91 | ppm |
| αATP Shift | −9.94 | ppm | −9.96 | ppm | −10.06 | ppm |
| βATP Shift | 18.40 | ppm | −18.44 | ppm | −18.57 | ppm |
| pH | 7.03 | | 7.11 | | 7.09 | |

Table 2: The J couplings, shifts, and pH's are given for the three reconstructed spectral shapes in human calf muscle. Key differences are shown in bold text. The shifts are given relative to PCr at −2.52 ppm and pH measurements are derived from the shift of the Pi peak. Uncertainties are ±0.5 Hz in coupling constants, ±0.04 ppm in shifts, and ±0.02 in pH.

It is encouraging that in the wide variety of spectral shapes and distributions studied, the method of the invention was able to find good solutions while using only minor constraints. For the 5-FU catabolism, PCA was used previously to obtain the same results, however the PCA basis shapes are orthogonal and generally require ad hoc transformations to reconstruct the spectral shapes. These spectral shapes are then used to determine the amplitude distribution. In contrast, the present method automatically determines the spectral shape and the amplitude for 5-FU and FBAL, removing the time necessary to reconstruct the spectral shapes and removing the uncertainty involved in the final result.

While the efficiency of automatic recovery of basis spectra is useful, the method of the invention demonstrates its real power on the larger and more complex datasets. In the case of the head data, the PCA analysis becomes more difficult. There is a problem of uniqueness in the transformation of the orthogonal shapes back into spectral shapes which is not present in the method of the invention, that is able to determine the spectral shapes and their distribution directly. Furthermore, in the case of the head, there is an additional, mathematically possible solution which can be discarded based on detailed physiological knowledge. The fact that the present method finds this solution demonstrates one of its great strengths: the method is not constrained by our preconceived ideas on what it should find, which allows one to more fully explore the realm of possible solutions, discarding those which can be discarded but retaining the others for further exploration.

In the case of the calf muscle, the present method offers the only method for recovering the strongly overlapping spectral shapes. In this case PCA calculates three orthogonal shapes which permit too many possible reconstructions into spectral shapes. Although the three orthogonal components clearly indicate the presence of differences within the muscle spectra at a level of a few percent of the total signal, interpretation of these differences without the unique reconstruction provided only by the method of the invention is virtually impossible. Since the present method reconstructs the actual spectral shapes as well as their amplitudes, it becomes possible to interpret the results in terms of different physical conditions. From the spectral shapes and distributions, it is clear that the calf muscle contains distinct spectral signatures, roughly aligned with the muscle groups. These signatures are present as mixtures within the individual muscles, with some types stronger within a given muscle than other types. For such a case with variations at only a few percent, the present method is the only method that was found to have a demonstrated ability to reconstruct true spectral shapes and distributions thereby allowing analysis of their physical quantities.

These results illustrate several of the strengths of the method of the invention. First, through the direct sampling of the actual posterior distribution, the method determines not only the mean results but also the true uncertainties at each spectral point and amplitude. Some methods give uncertainty estimates by treating the distribution of solutions as Gaussian. This is highly unlikely to be true, making such estimates inaccurate and potentially misleading. Second, methods which find solutions by inversion (such as FFT procedures) are prone to artifacts in sparsely sampled sets such as those shown. The method, on the other hand, creates possible solutions out of the “vacuum” and tests them against the data eliminating such artifacts. Third, the present method identifies mathematically possible solutions. Thus, when real multiple solutions are possible they are found. Often these additional solutions can be ruled out a posteriori, as in the case of the head data. However if the multiple solutions were all physically possible, then it is really not possible to decide on a “best” solution. If a single solution in a case like this were, in fact, determined by any method it would be extremely misleading. In contrast, by providing these multiple possible solutions, the method can guide further experimentation, allowing the discovery of correct, unique solutions when further constraints or data become available. Fourth, by determining both the spectral shapes and their fractional distribution within the voxels, the method allows a much purer reconstruction of the spectra associated with underlying tissue which is not spatially resolved than any other method. Finally, the method avoids biasing the results in any way. The method only “knows” the number of underlying spectra to look for and has no preference for one spectral shape over another.

In order to constrain the solution space adequately for the method to find acceptable solutions, the model was derived from a positive additive distribution. Fortunately, this type of distribution can represent many physical problems. In addition, it is necessary for the data to overdetermine the solutions, since Eq. [1] is degenerate in general. The degree of overdetermination necessary is likely to depend on the frequency overlap of the spectral shapes in the problem, since the spectra in solution space can then easily exchange flux. The calf muscle and simulation results show that for reconstruction of 3 strongly overlapping spectral shapes and their amplitude distributions, 100 spectra are adequate and probably even excessive at reasonable SNR.

While a number of Bayesian methods, usually coupled with single value decomposition procedures, have been introduced to solve various bilinear problems, the results have not proven the usefulness of adding the computationally intensive procedures. The work presented here dramatically demonstrates the power of the method of the invention to improve analysis of bilinear systems. The present method operates on the simple principle that by exploring the space of all possible solutions, equivalent to the phase space of statistical mechanics, while remaining cognizant of additional prior knowledge, the “best” answer together with its uncertainties must be the result.

### Example 2

Application of the Method to Analysis of Relaxographic Images

FIG. 15 illustrates the application of the method of the invention to a series of relaxographic images. Relaxographic imaging takes snapshots of the recovery of the magnetic spin following an inversion (Labadie et al., 1994, J. Magnetic Resonance B, 105:99). In this case, the matrix D of the method of the invention is a series of images (64 in the present case) sampled at different times. Every pixel in the 64×64 image should contain a mixture a exponential recovery curves, each curve corresponding to a tissue type. FIG. 15 shows the matrices A and F of the method, wherein F shows the fixed images for the white matter, gray matter and cerebrospinal fluid in the brain and A shows the time recovery curves of each of the fixed images for the 64 sampled recovery times.

### Example 3

Application of the Method to Analyses of Nucleic Acids

With the development of new acquisition methods which generate massive informational databases in clinical trials and biomedical experiments, the need for robust statistical approaches to extract the relevant information from these large and complex datasets is growing. Recent technological advances such as DNA chip arrays and combinatorial chemistry for drug discovery are presenting new challenges for analysis and interpretation of the data. Present analytical methods derived from statistical sciences are very good at reducing data to sets of patterns, however these patterns are generally nonphysical, representing mathematical constructs of the data which do not relate directly to the underlying physical process. Interpretation of these mathematical patterns in terms of physical quantities is generally problematic, often leading to multiple possible interpretations. There are a number of products (generally referred to as siftware) for looking at the output of gene arrays and cDNA hybridization experiments. However, none of these do well at finding patterns in the data. As noted in a recent review of the field (Klevecz, 1999, The Scientist, 22) the problem is the inability to find the patterns.

The method of the present invention provides the ability to analyze gene chip data and other expression array output, thereby leading to the discovery of the connection or pattern of genetic expression. It will likely replace siftware with a method that determines global relations rather than sifting out a few pieces of the data.

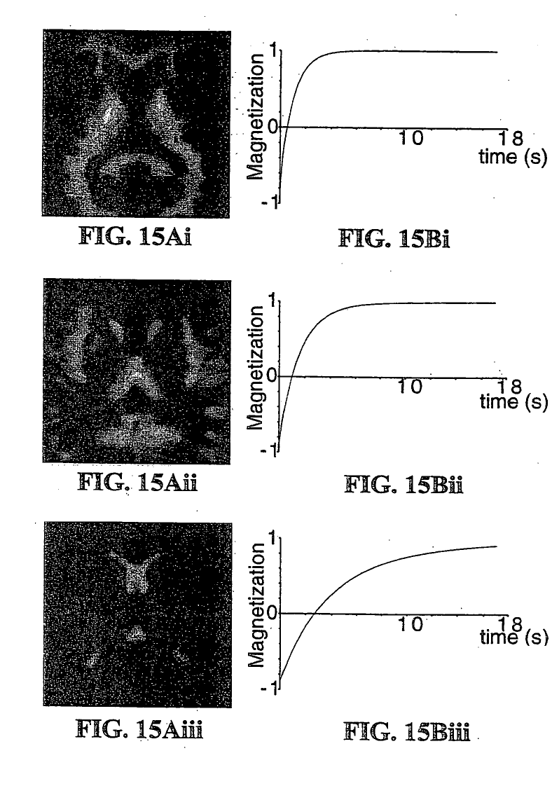

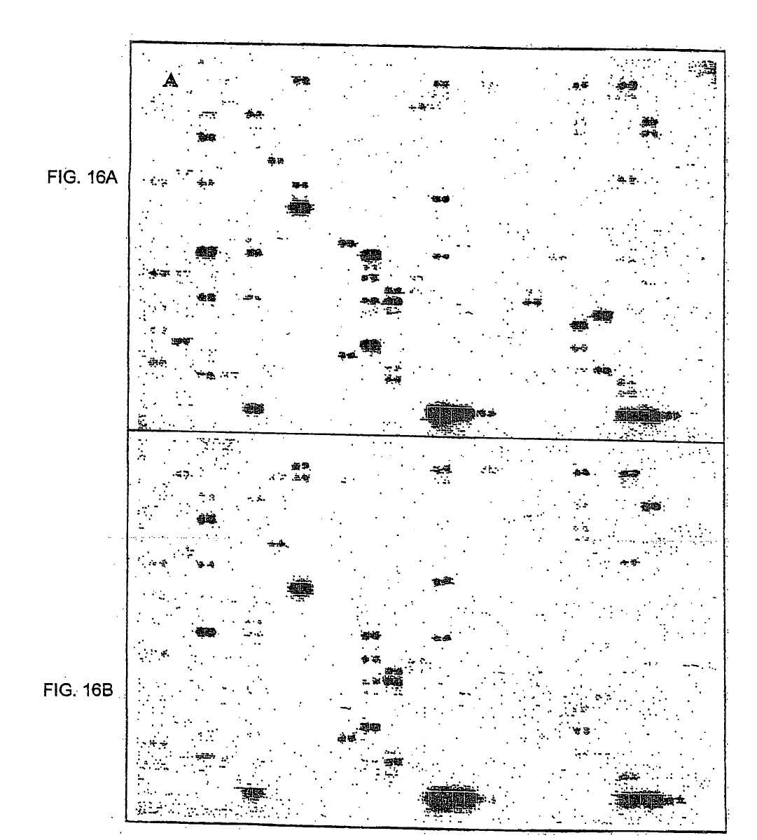

The growing use of gene chip technology has generated large datasets. These datasets often take the form of snapshots of genetic expression at different time points during some process of interest, e.g., the sporulation of yeast (Chu et al., 1998, Science 282:699). In essence, these datasets are a series of related measurements without a known functional relationship (such as exponential recovery). In order to explore the possibility that the method of the invention could be applicable to such datasets, scanned autoradiographic images of cDNA arrays were examined. The cDNA arrays are sets of specific cDNAs immobilized at low (10-20 cDNAs/cm²) to high (1000-6000 cDNAs/cm²) density on nylon-membrane or glass substrates (Ramsay, Nature Biotechnology 16:40). Complex cDNA probes with radioactive tags, derived in vivo by reverse transcription of poly(A)+ RNAs from a control cell line and from its tumorigenic counterpart, were directly hybridized to the immobilized DNAs. The resulting autoradiograph was scanned using a high quality scanner and digitized. The results of this experiment are shown in FIG. 16. The intensity of the individual spots on the radiographic image gives the level of the corresponding mRNA present in the cell at the time of the mRNA extraction. The image was converted into a single line of intensities (a spectrum) by measuring the intensities. By looking at a time series of such spectra we should be able to determine patterns of expression of the genes during oncogenesis and tumor progression.

For this preliminary investigation, it is important to have a known result to compare the output with, and since the biological patterns of gene expression are presently unknown, simulated data was chosen. Two of the images generated were used to generate data representing the state of knowledge of programmed cell death (apoptosis). There were four patterns in the data, two representing background genetic expression (cell cycle genes, etc.) and two patterns containing these genes with the addition of two different sets of genes being turned on at different stages of apoptosis. A series of 41 arrays-were generated with variation of expression of these patterns and noise was added to the data. After principle component analysis was run on the simulated data to confirm that there were four independent patterns, the method of the invention was used to attempt to recover these patterns. The solutions of the genetic patterns from the method showed the original two background patterns together with the sets of genes which underwent change. This occurred instead of direct identification of the four patterns since the method finds the minimal patterns required to reproduce the data, and the additional genes turned on during apoptosis was the minimal set in this case. The results together with the error are shown in FIG. 17 where the intensity of the spots in FIG. 16 are represented by flux at a point along a line as if we had converted the two dimensional image by scanning row by row.

It is apparent from the data provided in this example that the analytical methods disclosed herein may be applied to public domain data obtained using gene array chips, and to any other data relating to, for example but without limitation, changes in mRNA levels during the induction of programmed cell death by various chemopreventive agents. The invention is thus applicable to the identification of patterns in gene expression in different cell types and pathologies, which may thus serve as a basis for early diagnosis, selection of treatment, early prognosis of treatment response, and the discovery of patterns pointing to further pathways for the diagnosis and treatment of a variety of disease states.

To this end, other data which have been generated are now described. Over the past several years the human genome project initiative (HGPI) has generated a vast amount of sequence structure information for tens of thousands of genes and it is predicted that by the year 2003, the entire human genome will be cloned and sequenced. Growing out of the HGPI, is the powerful gene array technology which allows the assessment of the expression of hundreds to thousands of genes simultaneously. By combining the power of gene array chip technology with the methods presented herein, a powerful genetic tool for the identification of specific gene expression patterns associated with predisposition to different diseases or with different stages of disease, including cancer, and the response of individuals to chemopreventive or therapeutic treatment is available.

To evaluate the ability to extract efficiently and reliably the gene array data, the CLONTECH human Atlas™ cDNA expression arrays were evaluated. A pair of human tissue culture cell lines, a normal ovarian surface epithelial cell line (HIO-118) and a tumorigenic counterpart (EHO-118NuTu) were grown and mRNA was extracted therefrom. Multiple vector DNAs were included on the array as negative controls, along with a number of housekeeping gene cDNAs as positive controls. The genes included on the Atlas™ cDNA expression arrays are representatives of genes which play key roles in many different biological processes and are arrayed into functional classes.

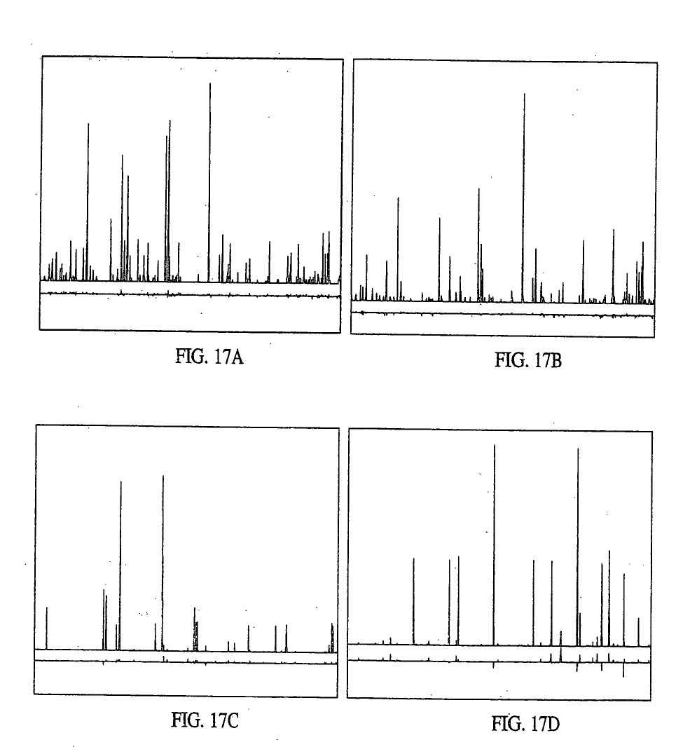

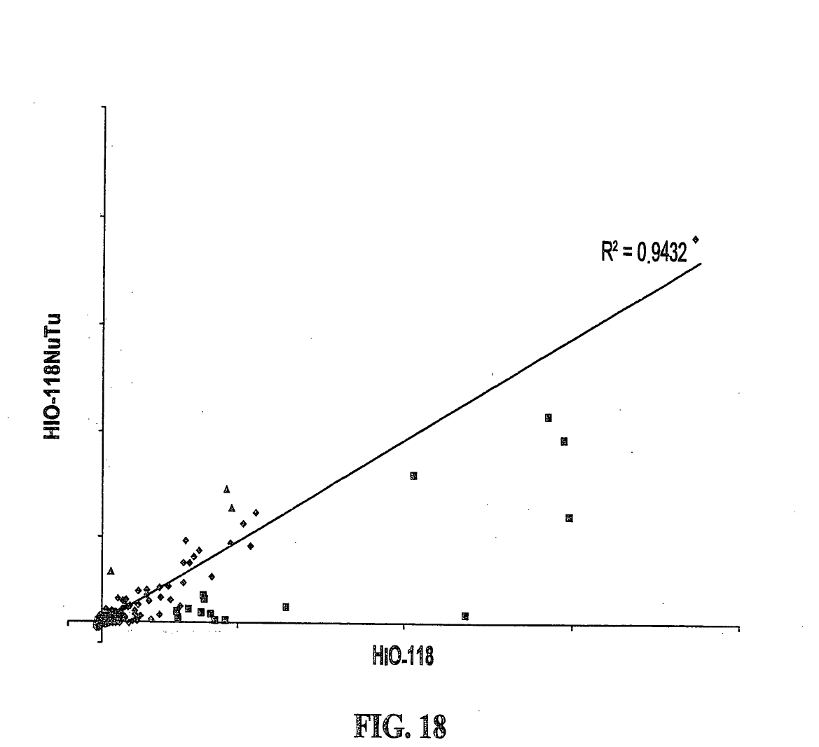

cDNA probes were obtained from each of the poly(A)+ mRNAs purified from early passages of the two cell lines and were hybridized to two identical Atlas™ cDNA arrays. Apart from a small number of differences, the pattern of gene expression, obtained with each of the two probes, was quite similar. The limited apparent differences, which suggests that background noise from the hybridization technology will be small, allows for the observation of relatively small quantitative changes in gene expression among different cell lines or treatments. The autoradiographic images shown in FIG. 18 represent the pattern of genes differentially expressed in HIO118 (A) and HIO-118NuTu (B). To process the obtained data and extract quantitative information with regard to the differential gene expression in the two cell lines, the autoradiograms were scanned. Custom software was created in Interactive Data Language (IDL) (Research Systems, Inc., CO) for reading the raw data and displaying it as an image, and for overlaying a 48×32 reference grid so that individual genes could be identified automatically (FIG. 18). The pixel intensities within the grid points were summed to obtain the corresponding level of gene expression. Using the variance in the intensities of the housekeeping genes as a measure of ‘noise’ variations in the data, three groups of genes were identified: 1) genes whose changes are within this noise level; 2) genes whose levels decrease or fully disappear in the transformed (HIO-118NuTu) cell line; and 3) genes whose intensities increase in the HIO-118NuTu cell line. These data are presented graphically as a correlation plot in FIG. 18. As was expected, the data without significant changes (diamonds) are strongly correlated (r²=0.94). The genes with decreased expression in the NuTu cell line appear in the lower portion of the graph (squares), and the genes with higher level of expression in the NuTu cell line appear in the upper portion (triangles). The list of genes undergoing major changes during the process of transformation can be automatically constructed by referring to the grid, and hence, the identity and function of the genes whose intensity values are off the middle line can be readily determined.

Using the techniques provided herein a wealth of quantitative information is obtained. It should be emphasized that the results presented herein were obtained rapidly and automatically, without any prior information or operator bids. Thus, it is now possible to generate multiple cDNA array data from different sets of human ovarian surface epithelial cells at different stages of malignant transformation and from cells that have been treated with different combinations of chemopreventive agents.

Once the nature of the noise in the gene chip data has been identified and quantified, a task well within the skill of the artisan with knowledge in the field, the method of the invention can be run to determine whether the treatment of noise as having a Gaussian distribution, presently built into the kernel, is acceptable for finding patterns in the data. The kernel uses this form of the noise to determine the likelihood of the model and the change in the likelihood during sampling.

### Example 4

Application of the Method to Econometric Data

This Example presents the results obtained in a pilot project wherein an aggregated set of credit card data was analyzed to determine the feasibility of using the method of the invention to develop a long-term forecasting model.

The data consisted of actual financial values for an aggregation of the credit card volume segments (called aggregates) for 132 variables (called attributes) over a period of 5 years. The description of the fields of the attributes was provided. The last three attributes in the data set were empty and for the purposes of the analysis they were ignored, reducing the total number of attributes to 129. There were also empty attributes within the data and in order to keep the structure of the data intact these attribute values were replaced with zeroes.

During visual inspection of the data, single data-points were noted to behave disproportionately from the neighboring points, in general they represented large jumps (in orders of magnitudes, including in some cases a sign change). Since there was no way to determine if these points were glitches or were reflecting a real change, these points were retained for the analysis.

The data set was analyzed using principal component analysis (PCA). PCA indicated that there were at least five patterns present in the data. The method of the invention was used to discover these patterns by searching the space of possible solutions. This was done by treating each month of actual values as a single row in the data matrix, D. The data matrix then comprised 58 rows of attributes, each row containing 129 attributes. The method determined that there were five patterns (pattern matrix, F) present and that these could explain the data set within the uncertainties. One of these patterns was discovered to be insignificant in terms of its effects on the attributes and it was discarded. The four remaining patterns explained relationships present between the attributes in the actual data and, together with the simultaneously determined time behavior of these patterns (distribution matrix, A), provide a description of the behavior of the credit card accounts represented.

The construction of an empirical model to represent the behavior of the credit card accounts represented in the aggregate is straightforward. The time behavior of each pattern is known, including points in time where a significant change has occurred. Working with domain experts within a credit card company, the event which gave rise to the significant change in behavior was discovered. The model then used the patterns of response to these identified events to create a forward-looking behavioral model of the credit card accounts to executive and marketing decision-makers. Because the discovered patterns were not clusters which forced all behavior of given attributes together, the interaction of various scenarios could be tested as the fractional response of a given attribute to a given identified event became known.

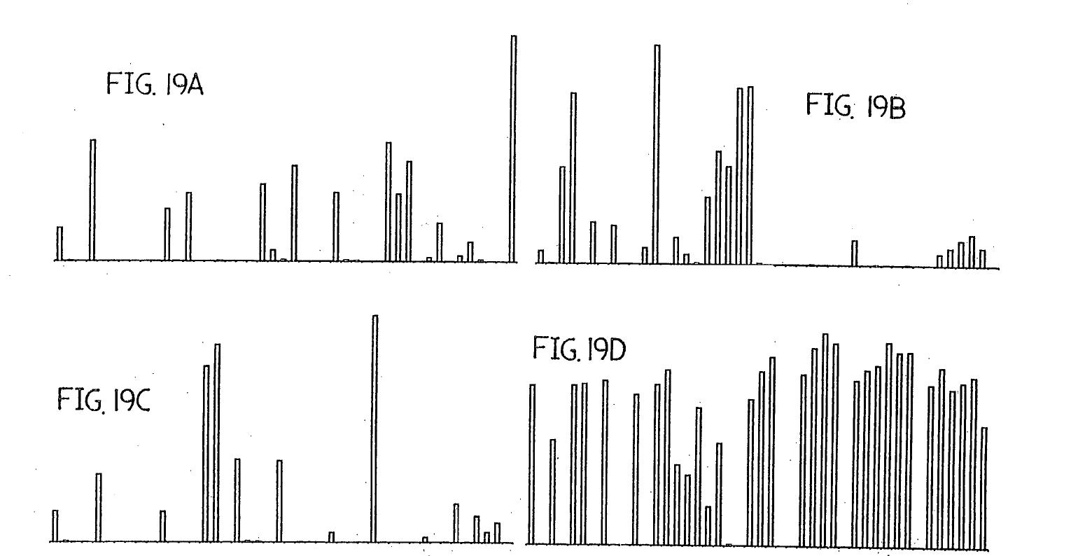

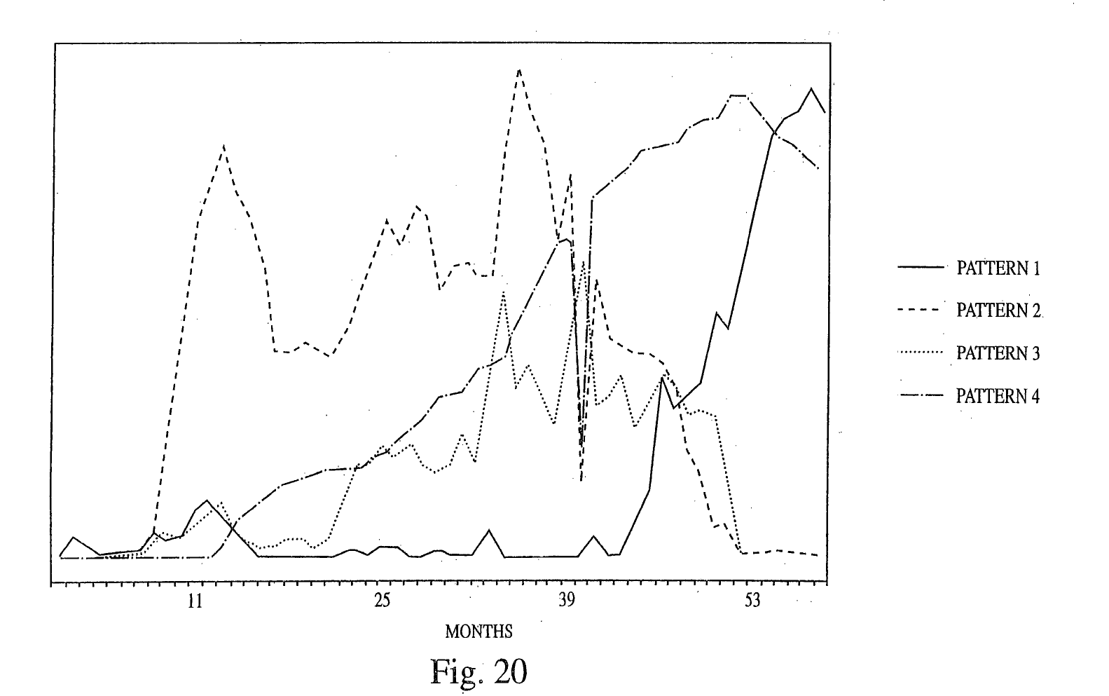

By analyzing the relationships present in past actuals, the method of the invention identified the relationships between key points within the business. In addition, the analysis performed according to the method of the invention identified the time behavior of these relationships, including key periods where the behavior changed substantially. For example, the actuals from the same credit card data cited above, yielded four patterns shown in FIG. 19. These patterns demonstrate that there exists a certain overall behavior (pattern 4) to the accounts, but that there are also some key relationships which can be exploited to increase the return on investment. In particular, pattern 1 shows a strong return (final point) which appears to be related to only a few of the other fields. Such information is not overly useful unless it can be coupled with an understanding of what gives rise to these couplings, which is provided through their distribution within the data (in this case through time). As can be seen in FIG. 20, pattern 1 appeared strongly only recently in the data. The actions or events which occurred to give rise to pattern 1 impacted the return, and modeling such an event requires the ability to disentangle the relationships which create pattern 1 from the other relationships which exist within the data. As demonstrated herein, the present method is capable of doing this.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A computer implemented process to identify at least one pattern and its distribution in a set of data for the purpose of interpreting the data, the process comprising:
(a) representing a set of data by an original data matrix D residing in a storage device, and;
(b) decomposing the set of data into a set of patterns represented by a matrix F and their distribution represented by a matrix A, wherein the matrix F represents the set of patterns needed to describe the data and the matrix A represents the distribution of the set of patterns within the data matrix D, the decomposing comprising performing a Bayesian-based Monte Carlo calculation using at least the data matrix D to determine the matrices A and F, wherein the matrices A and F reconstruct the data matrix D and are more amenable to analysis than the data matrix D.

2. A process according to claim 1 further comprising:
(c) determining by Monte Carlo sampling the uncertainties of all values in the elements of matrix F and matrix A.

3. A process according to claim 1 wherein the decomposing is performed such that the combined number of the elements in the matrices A and F are significantly smaller than the number of elements of the original data matrix, and the uncertainties in the matrices A and F combine to yield the correct uncertainty in matrix D, the significantly smaller number of elements making the matrices A and F more amenable to analysis than the data matrix D.

4. A process according to claim 1 further comprising:
(c) using a statistical process to determine the number of independent patterns required to reconstruct the original data matrix D within a noise level from the subordinate matrices A and F.

5. A process according to claim 4 wherein the independent patterns are spectral shapes.

6. A process according to claim 5 wherein the statistical process is principal component analysis, the process further comprising:
(c) using the principal component analysis to correct for any instrumental frequency or phase shifts which appear in spectra of the original data matrix D.

7. A process according to claim 5 wherein rows of the original data matrix D are chemical shift imaging spectra associated with specific locations in a living organism, rows of matrix F are individual nuclear magnetic resonance (NMR) spectra associated with different tissue types, and rows of matrix A are amounts of each tissue type at each specific location within the living organism.

8. A process according to claim 5 wherein rows of the original data matrix D are NMR spectra associated with specific time points during an observation of a living organism, rows of matrix F are individual NMR spectra associated with different chemical species, and rows of matrix A are amounts of each chemical species at each time point.

9. A process according to claim 1 wherein rows of the original data matrix D are NMR recovery curves associated with specific locations within a living organism, rows of matrix F are individual NMR recovery curves associated with different tissue types, and rows of matrix A are amounts of each tissue type at each specific location within the living organism.

10. A process according to claim 1 wherein rows of the original data matrix D are levels of expression of individual messenger RNA (mRNA) species at specific times, rows of matrix F are patterns of physiologically related mRNA expression, and rows of matrix A are amounts of each expression pattern at each specific point in time.

11. A process according to claim 10 further comprising:
(c) measuring the mRNA levels by adding a detectable label to DNA derived from the mRNA; and
(d) quantitating the amount of label associated with the DNA as a measure of the mRNA levels.

12. A process according to claim 11 wherein the label is selected from the group consisting of a radioactive label and a non-radioactive label.

13. A process according to claim 10 wherein expression of the mRNA is measured by synthesizing a DNA molecule which is complementary to the mRNA and detecting the amount of DNA synthesized.

14. A process according to claim 13 wherein the DNA molecule is synthesized in a reverse transcriptase reaction.

15. A process according to claim 13 wherein the amount of DNA synthesized is measured by:
(c) adding a detectable label to the DNA; and
(d) quantitating the amount of label associated with the DNA as a measure of the amount of DNA synthesized.

16. A process according to claim 15 wherein the label is selected from the group consisting of a radioactive label and a non-radioactive label.

17. A process according to claim 10 wherein expression of the “mRNA is measured by amplifying the “mRNA to DNA and detecting the amount of DNA so amplified.

18. A process according to claim 17 wherein the amplifying is conducted in a polymerase chain reaction.

19. A process according to claim 10 wherein the mRNA levels are measured using an array.

20. A process according to claim 19 wherein the array is a high density gene chip array.

21. The process according to claim 19 wherein the array is a low density array.

22. The process according to claim 21 wherein the low density array is a filter or a plate array.

23. A process according to claim 1 wherein rows of the original data matrix D are levels of expression of individual messenger RNA (mRNA) species at specific locations within a living organism, rows of matrix F are patterns of physiologically related mRNA expression, and rows of matrix A are amounts of each expression pattern at each specific location in the organism.

24. A process according to claim 23 further comprising:
(c) measuring the mRNA levels by adding a detectable label to DNA derived from the mRNA; and
(d) quantitating the amount of label associated with the DNA as a measure of the mRNA levels.

25. A process according to claim 24 wherein the label is selected from the group consisting of a radioactive label and a non-radioactive label.

26. A process according to claim 23 wherein expression of the mRNA is measured by synthesizing a DNA molecule which is complementary to the mRNA and detecting the amount of DNA synthesized.

27. A process according to claim 26 wherein the DNA molecule is synthesized in a reverse transcriptase reaction.

28. A process according to claim 26 wherein the amount of DNA synthesized is measured by
(c) adding a detectable label to the DNA; and
(d) quantitating the amount of label associated with the DNA as a measure of the amount of DNA synthesized.

29. A process according to claim 28 wherein the label is selected from the group consisting of a radioactive label and a non-radioactive label.

30. A process according to claim 23 wherein expression of the mRNA is measured by amplifying the mRNA to DNA and detecting the amount of DNA so amplified.

31. A process according to claim 30 wherein the amplifying is conducted in a polymerase chain reaction.

32. A process according to claim 23 wherein the expression of mRNA is measured using an array.

33. A process according to claim 32 wherein the array is a high density gene chip array.

34. The process according to claim 32 wherein the array is a low density array.

35. The process according to claim 34 wherein the low density array is a filter or a plate array.

36. A process according to claim 1 wherein rows of the original data matrix D are amounts of individual DNA species in specific individuals, rows of matrix F are patterns of physiologically related DNA species, and rows of matrix A are amounts of each DNA pattern in each individual.

37. A process according to claim 36 wherein the amount of DNA is measured by hybridizing to the DNA a complementary DNA having a detectable label attached thereto and measuring the amount of label so hybridized as a measure of the amount of DNA.

38. A process according to claim 37 wherein the label is selected from the group consisting of a radioactive and a non-radioactive label.

39. A process according to claim 36 wherein the amount of individual DNA is measured by synthesizing a DNA copy of the DNA to generate a synthesized DNA, wherein the synthesized DNA has a detectable label attached thereto and measuring the amount of label in the synthesized DNA as a measure of the amount of DNA.

40. The process according to claim 39 wherein the label is selected from the group consisting of a radioactive label and a non-radioactive label.

41. A process according to claim 36 further comprising:
(c) measuring the amount of DNA (non-amplified DNA) by amplifying the DNA (amplified DNA) in the presence of a detectable label; and
(d) measuring the amount of label associated with the amplified DNA as a measure of the amount of non-amplified DNA.

42. A process according to claim 41 wherein the detectable label is selected from the group consisting of a radioactive label and a non-radioactive label.

43. A process according to claim 41 wherein the amplifying is conducted by a polymerase chain reaction.

44. A process according to claim 36 wherein the amount of individual DNA is measured on an array.

45. A process according to claim 44 wherein the array is a high density gene chip array.

46. The process according to claim 44 wherein the array is a low density array.

47. The process according to claim 46 wherein the low density array is a filter or a plate array.

48. A process according to claim 1 wherein rows of the original data matrix D are amounts of individual DNA species at specific locations in a living organism, rows of matrix F are patterns of physiologically related DNA species, and rows of matrix A are amounts of each DNA pattern at each specific location in the organism.

49. A process according to claim 48 wherein the amount of DNA is measured by hybridizing to the DNA a complementary DNA having a detectable label attached thereto and measuring the amount of label so hybridized as a measure of the amount of DNA.

50. A process according to claim 49 wherein the label is selected from the group consisting of a radioactive and a non-radioactive label.

51. A process according to claim 48 wherein the amount of individual DNA is measured by synthesizing a DNA copy of the DNA to generate a synthesized DNA, wherein the synthesized DNA has a detectable label attached thereto and measuring the amount of label in the synthesized DNA as a measure of the amount of DNA.

52. The process according to claim 51 wherein the label is selected from the group consisting of a radioactive label and a non-radioactive label.

53. A process according to claim 48 further comprising:
(c) measuring the amount of DNA (non-amplified DNA) by amplifying the DNA (amplified DNA) in the presence of a detectable label; and
(d) measuring the amount of label associated with the amplified DNA as a measure of the amount of non-amplified DNA.

54. A process according to claim 53 wherein the detectable label is selected from the group consisting of a radioactive label and a non-radioactive label.

55. A process according to claim 53 wherein the amplifying is conducted by a polymerase chain reaction.

56. A process according to claim 48, wherein the amount of individual DNA is measured on an array.

57. A process according to claim 56 wherein the array is a high density gene chip array.

58. The process according to claim 56 wherein the array is a low density array.

59. The process according to claim 58 wherein the low density array is a filter or a plate array.

60. A process according to claim 1 wherein rows of the original data matrix D are amounts of individual DNA species at different times in a living organism, rows of matrix F are patterns of physiologically related DNA species, and rows of matrix A are amounts of each expression pattern at each specific point in time.

61. A process according to claim 60 wherein the amount of DNA is measured by hybridizing to the DNA a complementary DNA having a detectable label attached thereto and measuring the amount of label so hybridized as a measure of the amount of DNA.

62. A process according to claim 61 wherein the label is selected from the group consisting of a radioactive and a non-radioactive label.

63. A process according to claim 60 wherein the amount of individual DNA is measured by synthesizing a DNA copy of the DNA to generate a synthesized DNA, wherein the synthesized DNA has a detectable label attached thereto and measuring the amount of label in the synthesized DNA as a measure of the amount of DNA.

64. The process according to claim 63 wherein the label is selected from the group consisting of a radioactive label and a non-radioactive label.

65. A process according to claim 64 further comprising:
(c) measuring the amount of DNA (non-amplified DNA) by amplifying the DNA (amplified DNA) in the presence of a detectable label; and
(d) measuring the amount of label associated with the amplified DNA as a measure of the amount of non-amplified DNA.

66. A process according to claim 65 wherein the detectable label is selected from the group consisting of a radioactive label and a non-radioactive label.

67. A process according to claim 65 wherein the amplifying is conducted by a polymerase chain reaction.

68. A process according to claim 60 wherein the amount of individual DNA is measured on an array.

69. A process according to claim 68 wherein the array is a high density gene chip array.

70. The process according to claim 68 wherein the array is a low density array.

71. The process according to claim 70 wherein the low density array is a filter or a plate array.

72. The process according to claim 1 wherein rows of the original data matrix D are measurements of individual samples comprising mixtures of chemical compounds, rows of matrix F are the measurements associated with a single chemical compound, and rows of matrix A are amounts of each chemical compound in each of the individual samples.

73. The process according to claim 72 wherein the rows of the data matrix D are gas chromatography/mass spectra (GCMS) measurements, and the rows of matrix F are the GCMS spectra for the individual chemical compounds.

74. The process according to claim 72 wherein the rows of the data matrix D are infrared spectroscopy measurements, and the rows of matrix F are the infrared spectra for the individual chemical compounds.

75. The process according to claim 72 wherein the rows of the data matrix D are optical absorption spectroscopy measurements, and the rows of matrix F are the optical absorption spectra for the individual chemical compounds.

76. The process according to claim 72 wherein the rows of the data matrix D are fluorescence spectroscopy measurements, and the rows of matrix F are the fluorescence spectra for the individual chemical compounds.

77. The process according to claim 72 wherein the rows of the data matrix D are high pressure liquid chromatography/standard detection measurements, and the rows of matrix F are the spectra for the individual chemical compounds, wherein the spectra are selected from the group consisting of GCMS spectra, infrared spectra, optical absorption spectra and fluorescence spectra.

78. The process according to claim 1 wherein at least one pattern is an amount of goods or services.

79. The process according to claim 1, wherein the rows of the data matrix D are amounts of goods and services at various times, the rows of matrix F are the patterns of goods and services, and the rows of matrix A are a measure of how the amounts of goods and services are distributed over time.

80. The process according to claim 1, wherein the rows of the data matrix D are amounts of goods and services at various locations, the rows of matrix F are the patterns of goods and services, and the rows of matrix A are a measure of how the amounts of goods and services are distributed over various locations.

81. The process according to claim 1 wherein at least one pattern is a monetary value.

82. The process according to claim 1 wherein the pattern distribution is across entities.

83. The process according to claim 1 wherein the pattern distribution is across a space or a location.

84. The process according to claim 1 wherein the pattern distribution is across time.

85. The process according to claim 1 wherein representing a set of data by an original data matrix D involves counting a number of occurrences of events within the set of data and encoding the number of occurrences into the original data matrix D.

86. The process according to claim 1 wherein the original data matrix D is a set of spatially dependent functions, matrix F is a fixed set of spatially dependent functions, and matrix A is a distribution of the fixed spatially dependent functions within the data matrix D.

87. The process according to claim 1 wherein the original data matrix D is a series of images, matrix F is a set of unvarying images and A is a measure of how the images in matrix F are distributed in data matrix D.

88. The process according to claim 87 wherein the original data matrix D is a set of images acquired at different wavelengths.

89. The process according to claim 87 wherein the original data matrix D is a set of images acquired at different times.

90. The process according to claim 1 wherein the data matrix D is a set of measurements representing behavioral studies.

91. The process according to claim 1 wherein the data matrix D is a set of measurements representing clinical studies.

92. The process according to claim 1 wherein the data matrix D is a set of measurements representing biomedical research studies.

93. The process according to claim 1 wherein the data matrix D is a set of measurements representing psychodynamic studies.
